(19) United States
(12) Patent Application Publication
(10) Pub. No.: US 2026/0186247 A1
(43) Pub. Date: Jul. 2, 2026

(54) OPTICAL IMAGING LENS

(71) Applicant: GENIUS ELECTRONIC OPTICAL (XIAMEN) CO., LTD., Xiamen (CN)

(72) Inventors: Songchao Huang, Xiamen (CN); Huabin Liao, Xiamen (CN); Songlin Yang, Xiamen (CN); Hung-Chien Hsieh, Xiamen (CN)

(73) Assignee: GENIUS ELECTRONIC OPTICAL (XIAMEN) CO., LTD., Xiamen (CN)

(21) Appl. No.: 19/063,300

(22) Filed: Feb. 26, 2025

(30) Foreign Application Priority Data
Dec. 30, 2024 (CN) 202411975651.2

(51) Int. Cl. G02B 13/00; G02B 9/36

(52) U.S. Cl. CPC G02B 13/004; G02B 9/36; G02B 13/0055

(57) ABSTRACT

An optical imaging lens includes first to fourth lens elements sequentially arranged along an optical axis from an object side to an image side, and each including an object-side surface facing the object side and allowing an imaging ray to pass through and an image-side surface facing the image side and allowing the imaging ray to pass through. An optical axis region of the image-side surface of the third lens element is concave. A periphery region of the object-side surface of the fourth lens element is convex. An optical axis region of the image-side surface of the fourth lens element is concave. A periphery region of the image-side surface of the fourth lens element is convex. Lens elements of the optical imaging lens are only the four lens elements described above.

### CROSS-REFERENCE TO RELATED APPLICATION

This application claims the priority benefit of China application serial no. 202411975651.2, filed on Dec. 30, 2024. The entirety of the above-mentioned patent application is hereby incorporated by reference herein and made a part of this specification.

### BACKGROUND

### Technical Field

The disclosure relates to an optical element, and particularly relates to an optical imaging lens.

### Description of Related Art

The specifications of portable electronic devices are evolving rapidly, and their key components—optical imaging lenses—are also developing in increasingly diverse ways. For the main lens of the portable electronic devices, not only is a larger aperture required while maintaining a shorter system length, but higher pixel count and higher resolution are also pursued. In recent years, optical imaging lenses have been continuously evolving, and the range of applications has become wider. In addition to requirements for light, thin, short, and small lenses, the design of a small f-number (Fno) facilitates an increase in the luminous flux. How to design an optical imaging lens that is light, thin, short, and small, has a small f-number, and has good imaging quality has become an issue to be challenged and solved.

### SUMMARY

The disclosure provides an optical imaging lens that provides a lens with a small f-number and favorable imaging quality.

The disclosure provides an optical imaging lens including a first lens element, a second lens element, a third lens element, and a fourth lens element sequentially arranged along an optical axis from an object side to an image side. Each of the first lens element to the fourth lens element includes an object-side surface facing the object side and allowing an imaging ray to pass through and an image-side surface facing the image side and allowing the imaging ray to pass through. An optical axis region of the image-side surface of the third lens element is concave. A periphery region of the object-side surface of the fourth lens element is convex. An optical axis region of the image-side surface of the fourth lens element is concave. A periphery region of the image-side surface of the fourth lens is convex. Lens elements of the optical imaging lens are only the four lens elements described above, and satisfy EPD/AAG≥2.500, where EPD is an entrance pupil diameter of the optical imaging lens, and AAG is a sum of three air gaps along the optical axis between the first lens elements and the fourth lens elements.

The disclosure further provides an optical imaging lens including a first lens element, a second lens element, a third lens element, and a fourth lens element sequentially arranged along an optical axis from an object side to an image side. Each of the first lens element to the fourth lens element includes an object-side surface facing the object side and allowing an imaging ray to pass through and an image-side surface facing the image side and allowing the imaging ray to pass through. A periphery region of the object-side surface of the third lens element is convex. An optical axis region of the image-side surface of the third lens element is concave. A periphery region of the object-side surface of the fourth lens element is convex. An optical axis region of the image-side surface of the fourth lens element is concave. A periphery region of the image-side surface of the fourth lens element is convex. Lens elements of the optical imaging lens are only the four lens elements described above, and satisfy EPD/(AAG+BFL)≥1.000, where EPD is an entrance pupil diameter of the optical imaging lens, AAG is a sum of three air gaps along the optical axis between the first lens element and the fourth lens element, and BFL is a distance from the image-side surface of the fourth lens element to an image plane on the optical axis.

The disclosure further provides an optical imaging lens including a first lens element, a second lens element, a third lens element, and a fourth lens element sequentially arranged along an optical axis from an object side to an image side. Each of the first lens element to the fourth lens element includes an object-side surface facing the object side and allowing an imaging ray to pass through and an image-side surface facing the image side and allowing the imaging ray to pass through. A periphery region of the object-side surface of the third lens element is convex. An optical axis region of the image-side surface of the fourth lens element is concave. A periphery region of the image-side surface of the fourth lens element is convex. Lens elements of the optical imaging lens are only the four lens elements described above, and satisfy EPD/ImgH≥2.600, where EPD is an entrance pupil diameter of the optical imaging lens, and ImgH is a maximum image height of the optical imaging lens.

Based on the foregoing, in the optical imaging lens of the embodiments of the disclosure: the optical imaging lens provides a lens with a small f-number and favorable imaging quality, which may be applied in the blue light wavelength range of 400 to 500 nm and has significant improvement effects on field curvature, distortion, or longitudinal aberration, thereby reflecting good MTF resolution and imaging quality.

To make the aforementioned more comprehensible, several embodiments accompanied with drawings are described in detail as follows.

### BRIEF DESCRIPTION OF THE DRAWINGS

FIG. 1 is a schematic diagram showing a surface shape structure of a lens element.

FIG. 2 is a schematic diagram showing a concave-convex structure and a point of intersection of rays of a lens element.

FIG. 3 is a schematic diagram showing a surface shape structure of a lens element of Example 1.

FIG. 4 is a schematic diagram showing a surface shape structure of a lens element of Example 2.

FIG. 5 is a schematic diagram showing a surface shape structure of a lens element of Example 3.

FIG. 6 is a schematic diagram of an optical imaging lens of a first embodiment of the disclosure.

FIG. 7A to FIG. 7D are diagrams of a longitudinal spherical aberration and various optical aberrations of the optical imaging lens of the first embodiment.

FIG. 8 shows detailed optical data of the optical imaging lens of the first embodiment of the disclosure.

FIG. 9 shows aspheric parameters of the optical imaging lens of the first embodiment of the disclosure.

FIG. 10 is a schematic diagram of an optical imaging lens of a second embodiment of the disclosure.

FIG. 11A to FIG. 11D are diagrams of a longitudinal spherical aberration and various optical aberrations of the optical imaging lens of the second embodiment.

FIG. 12 shows detailed optical data of the optical imaging lens of the second embodiment of the disclosure.

FIG. 13 shows aspheric parameters of the optical imaging lens of the second embodiment of the disclosure.

FIG. 14 is a schematic diagram of an optical imaging lens of a third embodiment of the disclosure.

FIG. 15A to FIG. 15D are diagrams of a longitudinal spherical aberration and various optical aberrations of the optical imaging lens of the third embodiment.

FIG. 16 shows detailed optical data of the optical imaging lens of the third embodiment of the disclosure.

FIG. 17 shows aspheric parameters of the optical imaging lens of the third embodiment of the disclosure.

FIG. 18 is a schematic diagram of an optical imaging lens of a fourth embodiment of the disclosure.

FIG. 19A to FIG. 19D are diagrams of a longitudinal spherical aberration and various optical aberrations of the optical imaging lens of the fourth embodiment.

FIG. 20 shows detailed optical data of the optical imaging lens of the fourth embodiment of the disclosure.

FIG. 21 shows aspheric parameters of the optical imaging lens of the fourth embodiment of the disclosure.

FIG. 22 is a schematic diagram of an optical imaging lens of a fifth embodiment of the disclosure.

FIG. 23A to FIG. 23D are diagrams of a longitudinal spherical aberration and various optical aberrations of the optical imaging lens of the fifth embodiment.

FIG. 24 shows detailed optical data of the optical imaging lens of the fifth embodiment of the disclosure.

FIG. 25 shows aspheric parameters of the optical imaging lens of the fifth embodiment of the disclosure.

FIG. 26 is a schematic diagram of an optical imaging lens of a sixth embodiment of the disclosure.

FIG. 27A to FIG. 27D are diagrams of a longitudinal spherical aberration and various optical aberrations of the optical imaging lens of the sixth embodiment.

FIG. 28 shows detailed optical data of the optical imaging lens of the sixth embodiment of the disclosure.

FIG. 29 shows aspheric parameters of the optical imaging lens of the sixth embodiment of the disclosure.

FIG. 30 is a schematic diagram of an optical imaging lens of a seventh embodiment of the disclosure.

FIG. 31A to FIG. 31D are diagrams of a longitudinal spherical aberration and various optical aberrations of the optical imaging lens of the seventh embodiment.

FIG. 32 shows detailed optical data of the optical imaging lens of the seventh embodiment of the disclosure.

FIG. 33 shows aspheric parameters of the optical imaging lens of the seventh embodiment of the disclosure.

FIG. 34 is a schematic diagram of an optical imaging lens of an eighth embodiment of the disclosure.

FIG. 35A to FIG. 35D are diagrams of a longitudinal spherical aberration and various optical aberrations of the optical imaging lens of the eighth embodiment.

FIG. 36 shows detailed optical data of the optical imaging lens of the eighth embodiment of the disclosure.

FIG. 37 shows aspheric parameters of the optical imaging lens of the eighth embodiment of the disclosure.

FIG. 38 is a schematic diagram of an optical imaging lens of a ninth embodiment of the disclosure.

FIG. 39A to FIG. 39D are diagrams of a longitudinal spherical aberration and various optical aberrations of the optical imaging lens of the ninth embodiment.

FIG. 40 shows detailed optical data of the optical imaging lens of the ninth embodiment of the disclosure.

FIG. 41 shows aspheric parameters of the optical imaging lens of the ninth embodiment of the disclosure.

FIG. 42 and FIG. 43 show values of important parameters and their relational expressions of the optical imaging lenses of the first to fifth embodiments of the disclosure.

FIG. 44 and FIG. 45 show values of important parameters and their relational expressions of the optical imaging lenses of the sixth to ninth embodiments of the disclosure.

### DESCRIPTION OF THE EMBODIMENTS

The terms “optical axis region”, “periphery region”, “concave”, and “convex” used in this specification and claims should be interpreted based on the definition listed in the specification by the principle of lexicographer.

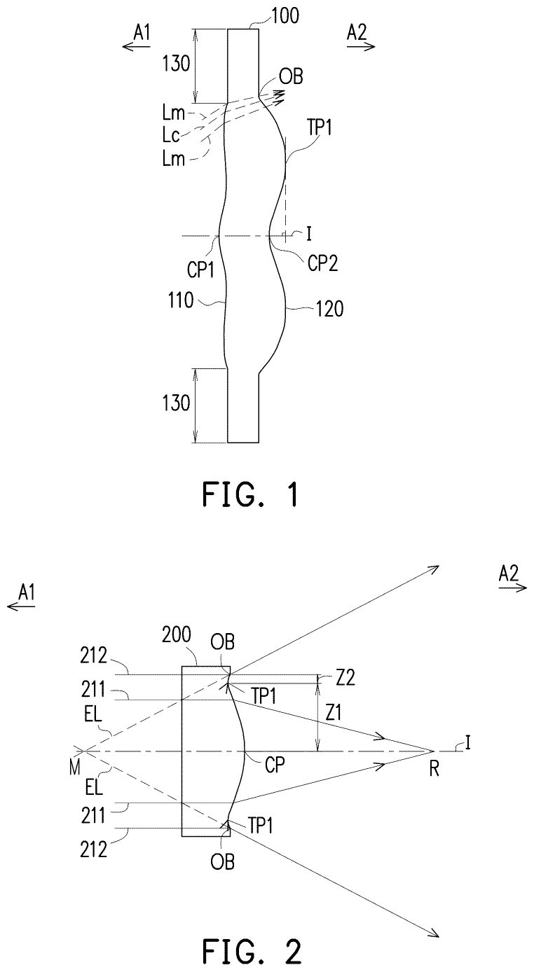

In the present disclosure, the optical system may comprise at least one lens element to receive imaging rays that are incident on the optical system over a set of angles ranging from parallel to an optical axis to a half field of view (HFOV) angle with respect to the optical axis. The imaging rays pass through the optical system to produce an image on an image plane. The term “a lens element having positive refracting power (or negative refracting power)” means that the paraxial refracting power of the lens element in Gaussian optics is positive (or negative). The term “an object-side (or image-side) surface of a lens element” refers to a specific region of that surface of the lens element at which imaging rays can pass through that specific region. Imaging rays include at least two types of rays: a chief ray Lc and a marginal ray Lm (as shown in FIG. 1). An object-side (or image-side) surface of a lens element can be characterized as having several regions, including an optical axis region, a periphery region, and, in some cases, one or more intermediate regions, as discussed more fully below.

FIG. 1 is a radial cross-sectional view of a lens element 100. Two referential points for the surfaces of the lens element 100 can be defined: a central point, and a transition point. The central point of a surface of a lens element is a point of intersection of that surface and the optical axis I. As illustrated in FIG. 1, a first central point CP1 may be present on the object-side surface 110 of lens element 100 and a second central point CP2 may be present on the image-side surface 120 of the lens element 100. The transition point is a point on a surface of a lens element, at which the line tangent to that point is perpendicular to the optical axis I. The optical boundary OB of a surface of the lens element is defined as a point at which the radially outermost marginal ray Lm passing through the surface of the lens element intersects the surface of the lens element. All transition points lie between the optical axis I and the optical boundary OB of the surface of the lens element. A surface of the lens element 100 may have no transition point or have at least one transition point. If multiple transition points are present on a single surface, then these transition points are sequentially named along the radial direction of the surface with reference numerals starting from the first transition point. For example, the first transition point, e.g., TP1, (closest to the optical axis I), the second transition point, e.g., TP2, (as shown in FIG. 4), and the Nth transition point (farthest from the optical axis I).

When a surface of the lens element has at least one transition point, the region of the surface of the lens element from the central point to the first transition point TP1 is defined as the optical axis region, which includes the central point. The region located radially outside of the farthest transition point (the Nth transition point) from the optical axis I to the optical boundary OB of the surface of the lens element is defined as the periphery region. In some embodiments, there may be intermediate regions present between the optical axis region and the periphery region, with the number of intermediate regions depending on the number of the transition points. When a surface of the lens element has no transition point, the optical axis region is defined as a region of 0%-50% of the distance between the optical axis I and the optical boundary OB of the surface of the lens element, and the periphery region is defined as a region of 50%-100% of the distance between the optical axis I and the optical boundary OB of the surface of the lens element.

The shape of a region is convex if a collimated ray being parallel to the optical axis I and passing through the region is bent toward the optical axis I such that the ray intersects the optical axis I on the image side A2 of the lens element. The shape of a region is concave if the extension line of a collimated ray being parallel to the optical axis I and passing through the region intersects the optical axis I on the object side A1 of the lens element.

Additionally, referring to FIG. 1, the lens element 100 may also have a mounting portion 130 extending radially outward from the optical boundary OB. The mounting portion 130 is typically used to physically secure the lens element to a corresponding element of the optical system (not shown). Imaging rays do not reach the mounting portion 130. The structure and shape of the mounting portion 130 are only examples to explain the technologies, and should not be taken as limiting the scope of the present disclosure. The mounting portion 130 of the lens elements discussed below may be partially or completely omitted in the following drawings.

Referring to FIG. 2, optical axis region Z1 is defined between central point CP and first transition point TP1. Periphery region Z2 is defined between TP1 and the optical boundary OB of the surface of the lens element. Collimated ray 211 intersects the optical axis I on the image side A2 of lens element 200 after passing through optical axis region Z1, i.e., the focal point of collimated ray 211 after passing through optical axis region Z1 is on the image side A2 of the lens element 200 at point R in FIG. 2. Accordingly, since the ray itself intersects the optical axis I on the image side A2 of the lens element 200, optical axis region Z1 is convex. On the contrary, collimated ray 212 diverges after passing through periphery region Z2. The extension line EL of collimated ray 212 after passing through periphery region Z2 intersects the optical axis I on the object side A1 of lens element 200, i.e., the focal point of collimated ray 212 after passing through periphery region Z2 is on the object side A1 at point M in FIG. 2. Accordingly, since the extension line EL of the ray intersects the optical axis I on the object side A1 of the lens element 200, periphery region Z2 is concave. In the lens element 200 illustrated in FIG. 2, the first transition point TP1 is the border of the optical axis region and the periphery region, i.e., TP1 is the point at which the shape changes from convex to concave.

Alternatively, there is another way for a person having ordinary skill in the art to determine whether an optical axis region is convex or concave by referring to the sign of “Radius of curvature” (the “R” value), which is the paraxial radius of shape of a lens surface in the optical axis region. The R value is commonly used in conventional optical design software such as Zemax and CodeV. The R value usually appears in the lens data sheet in the software. For an object-side surface, a positive R value defines that the optical axis region of the object-side surface is convex, and a negative R value defines that the optical axis region of the object-side surface is concave. Conversely, for an image-side surface, a positive R value defines that the optical axis region of the image-side surface is concave, and a negative R value defines that the optical axis region of the image-side surface is convex. The result found by using this method should be consistent with the method utilizing intersection of the optical axis by rays/extension lines mentioned above, which determines surface shape by referring to whether the focal point of a collimated ray being parallel to the optical axis I is on the object-side or the image-side of a lens element. As used herein, the terms “a shape of a region is convex (concave),” “a region is convex (concave),” and “a convex- (concave-) region,” can be used alternatively.

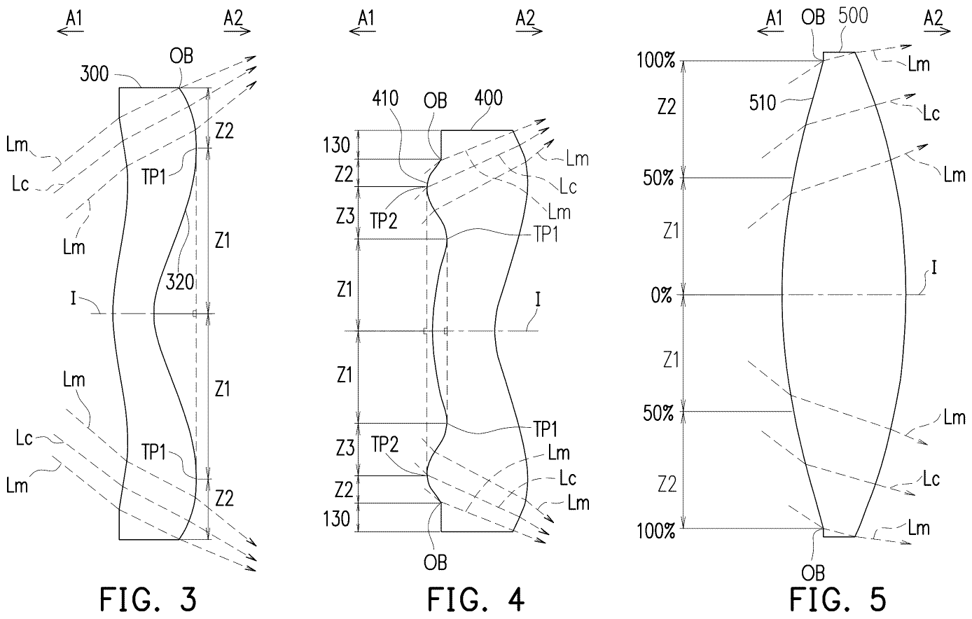

FIG. 3, FIG. 4 and FIG. 5 illustrate examples of determining the shape of lens element regions and the boundaries of regions under various circumstances, including the optical axis region, the periphery region, and intermediate regions as set forth in the present specification.

FIG. 3 is a radial cross-sectional view of a lens element 300. As illustrated in FIG. 3, only one transition point TP1 appears within the optical boundary OB of the image-side surface 320 of the lens element 300. Optical axis region Z1 and periphery region Z2 of the image-side surface 320 of lens element 300 are illustrated. The R value of the image-side surface 320 is positive (i.e., R>0). Accordingly, the optical axis region Z1 is concave.

In general, the shape of each region demarcated by the transition point will have an opposite shape to the shape of the adjacent region(s). Accordingly, the transition point will define a transition in shape, changing from concave to convex at the transition point or changing from convex to concave. In FIG. 3, since the shape of the optical axis region Z1 is concave, the shape of the periphery region Z2 will be convex as the shape changes at the transition point TP1.

FIG. 4 is a radial cross-sectional view of a lens element 400. Referring to FIG. 4, a first transition point TP1 and a second transition point TP2 are present on the object-side surface 410 of lens element 400. The optical axis region Z1 of the object-side surface 410 is defined between the optical axis I and the first transition point TP1. The R value of the object-side surface 410 is positive (i.e., R>0). Accordingly, the optical axis region Z1 is convex.

The periphery region Z2 of the object-side surface 410, which is also convex, is defined between the second transition point TP2 and the optical boundary OB of the object-side surface 410 of the lens element 400. Further, intermediate region Z3 of the object-side surface 410, which is concave, is defined between the first transition point TP1 and the second transition point TP2. Referring once again to FIG. 4, the object-side surface 410 includes an optical axis region Z1 located between the optical axis I and the first transition point TP1, an intermediate region Z3 located between the first transition point TP1 and the second transition point TP2, and a periphery region Z2 located between the second transition point TP2 and the optical boundary OB of the object-side surface 410. Since the shape of the optical axis region Z1 is designed to be convex, the shape of the intermediate region Z3 is concave as the shape of the intermediate region Z3 changes at the first transition point TP1, and the shape of the periphery region Z2 is convex as the shape of the periphery region Z2 changes at the second transition point TP2.

FIG. 5 is a radial cross-sectional view of a lens element 500. Lens element 500 has no transition point on the object-side surface 510 of the lens element 500. For a surface of a lens element with no transition point, for example, the object-side surface 510 the lens element 500, the optical axis region Z1 is defined as the region of 0%-50% of the distance between the optical axis I and the optical boundary OB of the surface of the lens element and the periphery region is defined as the region of 50%-100% of the distance between the optical axis I and the optical boundary OB of the surface of the lens element. Referring to lens element 500 illustrated in FIG. 5, the optical axis region Z1 of the object-side surface 510 is defined between the optical axis I and 50% of the distance between the optical axis I and the optical boundary OB. The R value of the object-side surface 510 is positive (i.e., R>0). Accordingly, the optical axis region Z1 is convex. For the object-side surface 510 of the lens element 500, because there is no transition point, the periphery region Z2 of the object-side surface 510 is also convex. It should be noted that lens element 500 may have a mounting portion (not shown) extending radially outward from the periphery region Z2.

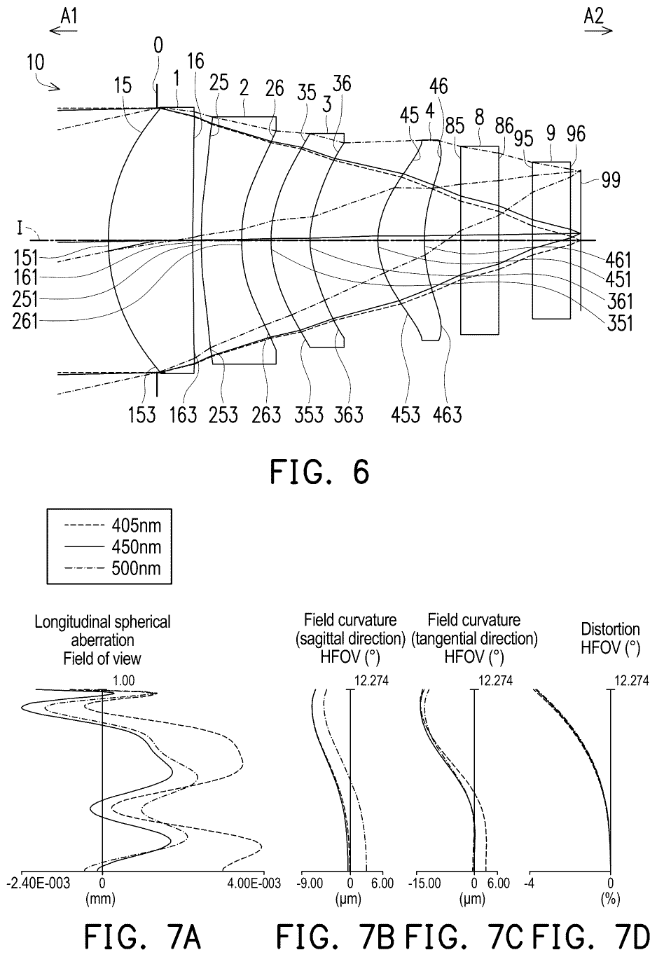

FIG. 6 is a schematic diagram of an optical imaging lens of a first embodiment of the disclosure. FIG. 7A to FIG. 7D are diagrams of a longitudinal spherical aberration and various optical aberrations of the optical imaging lens of the first embodiment. First, referring to FIG. 6, an optical imaging lens 10 of the first embodiment of the disclosure includes an aperture 0, a first lens element 1, a second lens element 2, a third lens element 3, a fourth lens element 4, a filter 8, and a protective cover plate 9 sequentially arranged along the optical axis I of the optical imaging lens 10 from the object side A1 to the image side A2. When rays emitted by an object to be photographed enter the optical imaging lens 10, the rays may form an image on an image plane 99 after passing through the aperture 0, the first lens element 1, the second lens element 2, the third lens element 3, the fourth lens element 4, the filter 8, and the protective cover plate 9. In addition, the object side A1 is a side facing the object to be photographed, and the image side A2 is a side facing the image plane 99. In this embodiment, the filter 8 is a band pass filter, and the protective cover plate 9 is a glass light-transmitting plate. The band pass filter is designed to have an average transmittance of light in the wavelength range of 360 to 380 nm being ≤3%; an average transmittance of light in the wavelength range of 400 to 500 nm being ≥95%; and an average transmittance of light in the wavelength range of 550 to 1150 nm being ≤3%.

In this embodiment, the first lens element 1, the second lens element 2, the third lens element 3, the fourth lens element 4, the filter 8, and the protective cover plate 9 of the optical imaging lens 10 respectively have object-side surfaces 15, 25, 35, 45, 85, 95 facing the object side A1 and allowing imaging rays to pass through and image-side surfaces 16, 26, 36, 46, 86, 96 facing the image side A2 and allowing the imaging rays to pass through. In this embodiment, the aperture 0 is arranged on a side of the first lens element 1 facing the object side A1.

The first lens element 1 has positive refracting power. An optical axis region 151 of the object-side surface 15 of the first lens element 1 is convex, and a periphery region 153 thereof is convex. An optical axis region 161 of the image-side surface 16 of the first lens element 1 is concave, and a periphery region 163 thereof is convex. In this embodiment, both the object-side surface 15 and the image-side surface 16 of the first lens element 1 are aspheric surfaces, but the disclosure is not limited thereto.

The second lens element 2 has negative refracting power. An optical axis region 251 of the object-side surface 25 of the second lens element 2 is convex, and a periphery region 253 thereof is convex. An optical axis region 261 of the image-side surface 26 of the second lens element 2 is concave, and a periphery region 263 thereof is concave. In this embodiment, both the object-side surface 25 and the image-side surface 26 of the second lens element 2 are aspheric surfaces, but the disclosure is not limited thereto.

The third lens element 3 has negative refracting power. An optical axis region 351 of the object-side surface 35 of the third lens element 3 is convex, and a periphery region 353 thereof is convex. An optical axis region 361 of the image-side surface 36 of the third lens element 3 is concave, and a periphery region 363 thereof is concave. In this embodiment, both the object-side surface 35 and the image-side surface 36 of the third lens element 3 are aspheric surfaces, but the disclosure is not limited thereto.

The fourth lens element 4 has positive refracting power. An optical axis region 451 of the object-side surface 45 of the fourth lens element 4 is convex, and a periphery region 453 thereof is convex. An optical axis region 461 of the image-side surface 46 of the fourth lens element 4 is concave, and a periphery region 463 thereof is convex. In this embodiment, both the object-side surface 45 and the image-side surface 46 of the fourth lens element 4 are aspheric surfaces, but the disclosure is not limited thereto.

In this embodiment, lens elements of the optical imaging lens 10 are only the four lens elements described above.

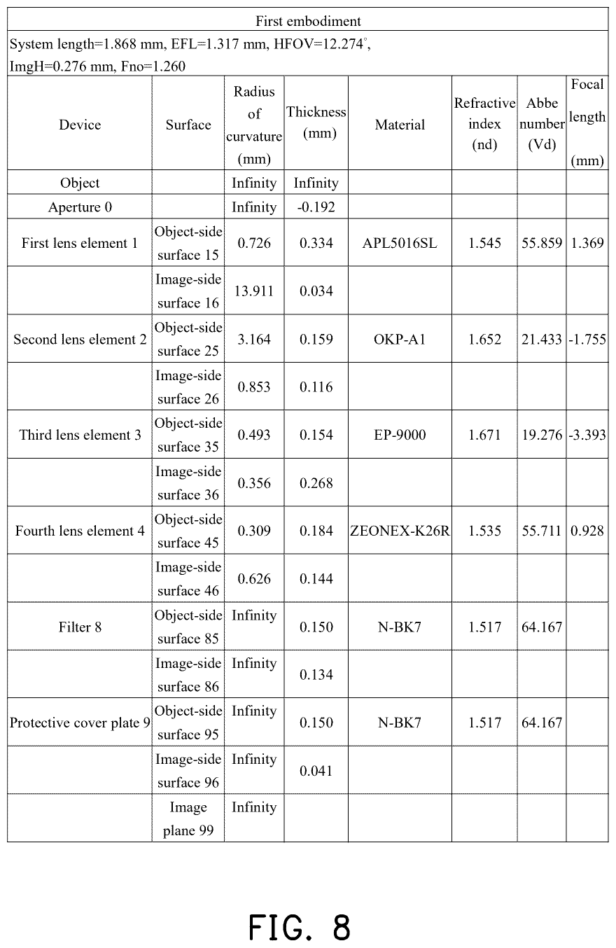

Other detailed optical data of the first embodiment is as shown in FIG. 8, and the optical imaging lens 10 of the first embodiment has an effective focal length (EFL) of 1.317 millimeters (mm), a half field of view (HFOV) of 12.274 degrees, a system length of 1.868 mm, an f-number (Fno) of 1.260, and an image height of 0.276 mm. The system length refers to a distance from the object-side surface 15 of the first lens element 1 to the image plane 99 on the optical axis I. The material parameters of the lens elements disclosed in the optical parameter table of the embodiment adopt the nd refractive index and Vd Abbe number format of the international glass code, so as to facilitate those skilled in the art to know the specific material implementation. The nd refractive index is the refractive index of the material at a d-line of helium of 587.56 nanometers (nm), and the Vd Abbe number is calculated based on the refractive indices of the material at the d, F, and C wavelengths of the Fraunhofer spectrum.

The focal length values disclosed in the optical parameter table of the embodiment are calculated based on the refractive indices of the optical system implemented waveband, and the primary wavelength implemented in this embodiment of the disclosure is 450 nm. Therefore, the focal length values of the disclosure are calculated based on the refractive indices of the materials at 450 nm.

In addition, in this embodiment, a total of eight surfaces, i.e., the object-side surfaces 15, 25, 35, 45 and the image-side surfaces 16, 26, 36, 46 of the first lens element 1, the second lens element 2, the third lens element 3, and the fourth lens element 4 are all aspheric surfaces. The object-side surfaces 15, 25, 35, 45 and the image-side surfaces 16, 26, 36, 46 are general even aspheric surfaces. These aspheric surfaces are defined according to Formula (1) below:

$$Z ( Y ) = \frac{{Y}^{2}}{R} / ( 1 + \sqrt{1 - ( 1 + K ) \frac{{Y}^{2}}{{R}^{2}}} ) + {\sum }_{i = 1}^{n} {a}_{i} \times {Y}^{i} \qquad ( 1 )$$

where
Y: a perpendicular distance between a point on an aspheric curve and the optical axis I;
Z: a depth of an aspheric surface (a perpendicular distance between a point on the aspheric surface that is spaced by the distance Y from the optical axis and a tangent plane tangent to a vertex of the aspheric surface on the optical axis I);
R: the radius of curvature of the lens element surface near the optical axis I;
K: a conic constant; and
ai: a i^{th}-order aspheric coefficient.

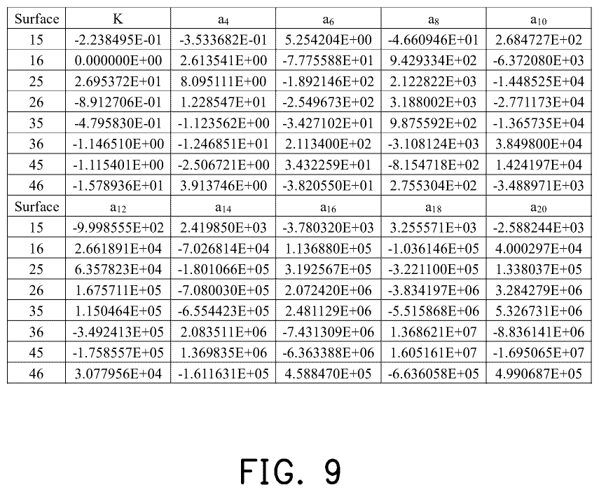

The aspheric coefficients of the object-side surface 15 of the first lens element 1 to the image-side surface 46 of the fourth lens element 4 in Formula (1) are as shown in FIG. 9. Field number 15 in FIG. 9 denotes an aspheric coefficient of the object-side surface 15 of the first lens element 1, and the other fields may be deducted by analogy. In this embodiment, the second-order aspheric coefficient a₂ of each aspheric surface is zero. Therefore, it is not listed in FIG. 9.

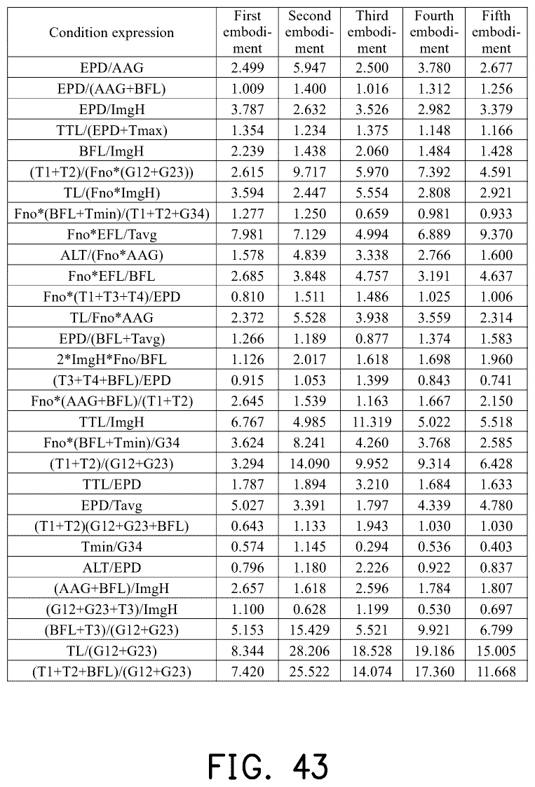

In addition, the relationships between important parameters in the optical imaging lens 10 of the first implementation are as shown in FIG. 42 to FIG. 43,
where
T1 is a thickness of the first lens element 1 on the optical axis I;
T2 is a thickness of the second lens element 2 on the optical axis I;
T3 is a thickness of the third lens element 3 on the optical axis I;
T4 is a thickness of the fourth lens element 4 on the optical axis I;
TF is a thickness of the filter 8 on the optical axis I;
CG is a thickness of the protective cover plate 9 on the optical axis I;
G12 is an air gap between the first lens element 1 and the second lens element 2 on the optical axis I;
G23 is an air gap between the second lens element 2 and the third lens element 3 on the optical axis I;
G34 is an air gap between the third lens element 3 and the fourth lens element 4 on the optical axis I;
G4F is an air gap between the fourth lens element 4 and the filter 8 on the optical axis I;
GFP is an air gap between the filter 8 and the image plane 99 on the optical axis I;
AAG is a sum of the three air gaps between the first lens element 1 to the fourth lens element 4 on the optical axis I, that is, a sum of G12, G23, and G34;
ALT is a sum of thicknesses of the four lens element from the first lens element 1 to the fourth lens element 4 on the optical axis I, that is, a sum of T1, T2, T3, and T4;
TL is a distance from the object-side surface 15 of the first lens element 1 to the image-side surface 46 of the fourth lens element 4 on the optical axis I;
TTL is a distance from the object-side surface 15 of the first lens element 1 to the image plane 99 on the optical axis I;
BFL is a distance from the image-side surface 46 of the fourth lens element 4 to the image plane 99 on the optical axis I, that is, a sum of G4F, TF, and GFP;
EFL is an effective focal length of the optical imaging lens 10;
HFOV is a half field of view of the optical imaging lens 10;
ImgH is an image height of the optical imaging lens 10;
Fno is an f-number of the optical imaging lens 10; and
EPD is the entrance pupil diameter of the optical imaging lens 10, which is equal to a ratio of the effective focal length to the f-number.

In addition, the following are further defined:
Tavg is an average value of thicknesses of the four lens element from the first lens element 1 to the fourth lens element 4 on the optical axis I, that is, an average value of T1, T2, T3, and T4;
Tmax is a maximum value of the thicknesses of the four lens element from the first lens element 1 to the fourth lens element 4 on the optical axis I, that is, a maximum value among T1, T2, T3, and T4;
Tmin is a minimum value of the thicknesses of the four lens element from the first lens element 1 to the fourth lens element 4 on the optical axis I, that is, a minimum value among T1, T2, T3, and T4;
Gmax is a maximum value of the three air gaps between the first lens element 1 to the fourth lens element 4 on the optical axis I, that is, a maximum value among G12, G23, and G34;
f1 is a focal length of the first lens element 1;
f2 is a focal length of the second lens element 2;
f3 is a focal length of the third lens element 3;
f4 is a focal length of the fourth lens element 4;
n1 is an nd refractive index of the first lens element 1;
n2 is an nd refractive index of the second lens element 2;
n3 is an nd refractive index of the third lens element 3;
n4 is an nd refractive index of the fourth lens element 4;
V1 is a Vd Abbe number of the first lens element 1;
V2 is a Vd Abbe number of the second lens element 2;
V3 is a Vd Abbe number of the third lens element 3; and
V4 is a Vd Abbe number of the fourth lens element 4.

Then, referring to FIG. 7A to FIG. 7D in conjunction, FIG. 7A is a diagram showing a longitudinal spherical aberration on the image plane 99 at wavelengths of 405 nm, 450 nm, and 500 nm in the first embodiment, FIG. 7B and FIG. 7C respectively show a field curvature aberration in a sagittal direction and a tangential direction on the image plane 99 at wavelengths of 405 nm, 450 nm, and 500 nm in the first embodiment, and FIG. 7D shows a distortion aberration on the image plane 99 at wavelengths of 405 nm, 450 nm, and 500 nm in the first embodiment. The longitudinal spherical aberration of the first embodiment is as shown in FIG. 7A. Curves formed by the wavelengths are very close to each other and are close to the middle, which indicates that off-axis rays at different heights at each wavelength are concentrated near an imaging point. It can be seen from the deflection amplitude of the curve at each wavelength that deviations of imaging points of the off-axis rays at different heights are controlled within a range of ±4.00E-003 micrometers. Therefore, this first embodiment, the spherical aberration of the same wavelength is obviously improved. In addition, distances between the three representative wavelengths are also quite close to each other, which indicates that imaging positions of rays at different wavelength are quite concentrated, so the chromatic aberration is also obviously improved.

In the two field curvature aberration diagrams of FIG. 7B and FIG. 7C, focal length variations of the three representative wavelengths within the entire field of view range fall within ±15.00 micrometers, which indicates that the optical system of the first embodiment may effectively alleviate the optical aberrations. The distortion aberration diagram of FIG. 7D shows that the distortion aberration of this embodiment is maintained within a range of ±4%, which indicates that the distortion aberration of the first embodiment meets the imaging quality requirements of the optical system. It is accordingly indicated that, compared with an existing optical lens, the first embodiment may still provide good imaging quality in a case where the system length is reduced to 1.868 millimeters. Therefore, the first embodiment may provide an optical imaging lens with a small f-number and favorable imaging quality while maintaining good optical performance.

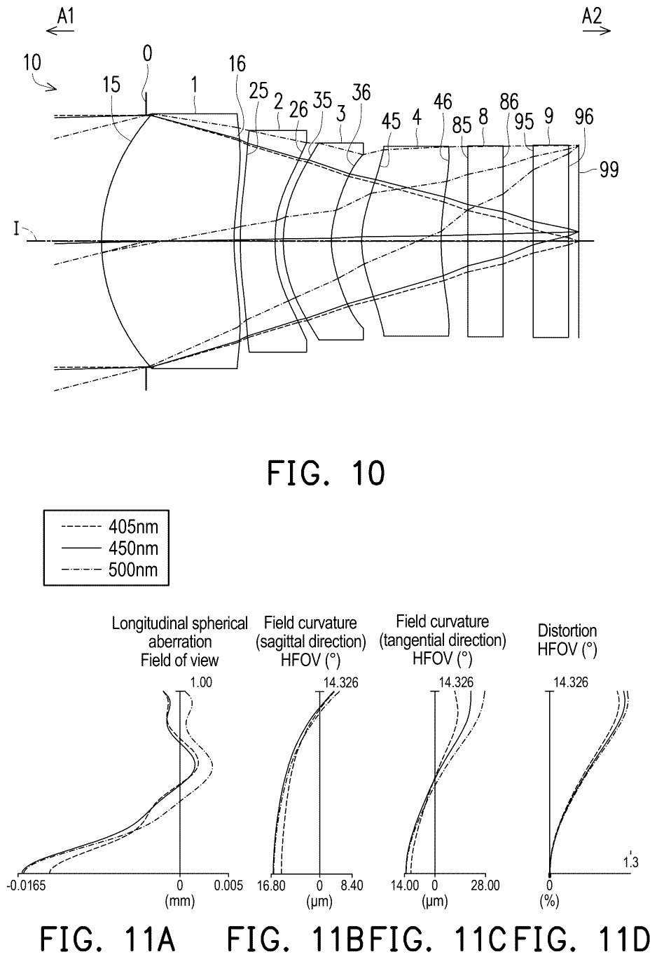

FIG. 10 is a schematic diagram of an optical imaging lens of a second embodiment of the disclosure. FIG. 11A to FIG. 11D are diagrams of a longitudinal spherical aberration and various optical aberrations of the optical imaging lens of the second embodiment. First, referring to FIG. 10, the second embodiment of the optical imaging lens 10 of the disclosure is approximately similar to the first embodiment, and their differences are as follows: the optical data, aspheric coefficients, and the parameters among the lens elements 1, 2, 3, and 4 are more or less different. It should be noted here that, in order to clearly show the figure, reference numerals of the optical axis regions and the periphery regions with surface shapes similar to those of the first embodiment are partially omitted in FIG. 10.

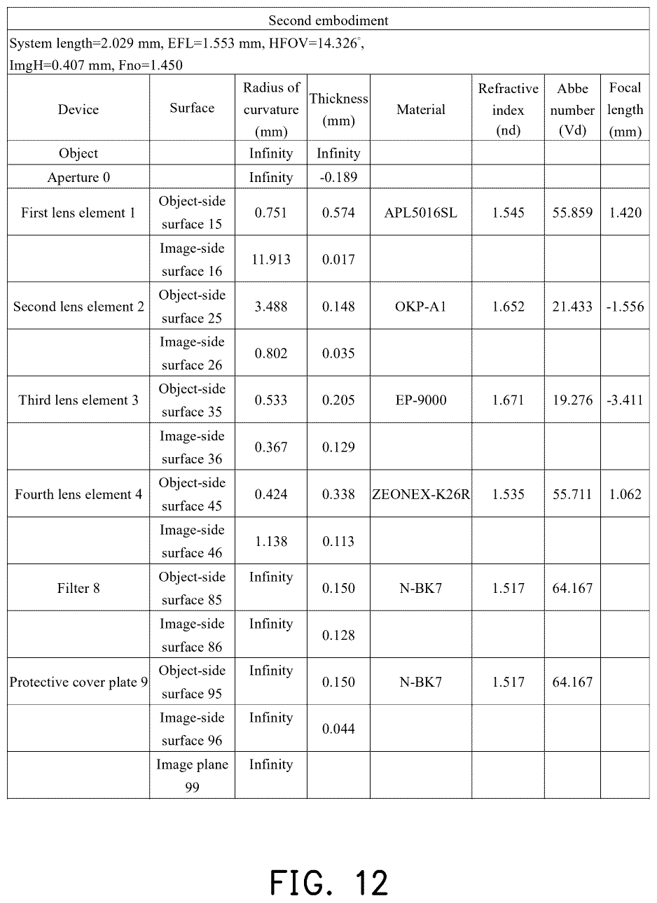

Detailed optical data of the optical imaging lens 10 of the second embodiment is as shown in FIG. 12, and the optical imaging lens 10 of the second embodiment has an effective focal length of 1.553 millimeters, a half field of view of 14.326 degrees, a system length of 2.029 millimeters, an f-number of 1.450, and an image height of 0.407 millimeters.

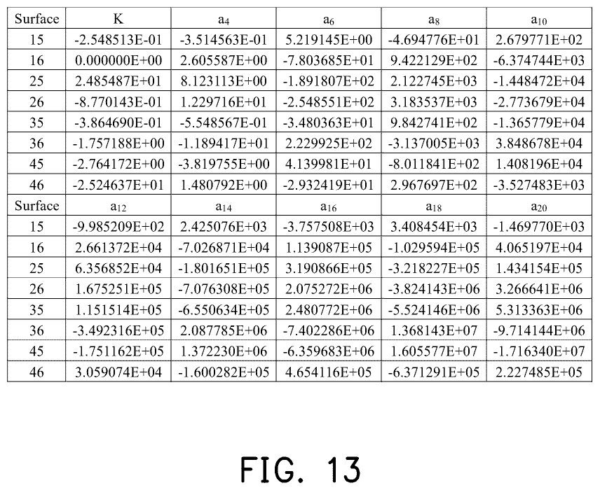

As shown in FIG. 13, FIG. 13 shows the aspheric coefficients of the object-side surface 15 of the first lens element 1 to the image-side surface 46 of the fourth lens element 4 of the second embodiment in Formula (1) above.

In addition, the relationships between important parameters in the optical imaging lens 10 of the second embodiment are as shown in FIG. 42 and FIG. 43.

The longitudinal spherical aberration of the second embodiment is as shown in FIG. 11A, and deviations of imaging points of off-axis rays at different heights are controlled within a range of ±0.0165 millimeters. In the two field curvature aberration diagrams of FIG. 11B and FIG. 11C, focal length variations of the three representative wavelengths within the entire field of view range fall within ±28.000 micrometers. The distortion aberration diagram of FIG. 11D shows that the distortion aberration of the embodiment is maintained within a range of ±1.3%.

From the above description, it can be known that the half field of view of the second embodiment is larger than the half field of view of the first embodiment. Therefore, compared with the first embodiment, the second embodiment has a larger angle range for receiving images. The image height of the second embodiment is larger than the image height of the first embodiment. Therefore, compared with the first embodiment, the second embodiment has better sensitivity. Furthermore, the distortion aberration of the second embodiment is smaller than the distortion aberration of the first embodiment, resulting in better imaging quality.

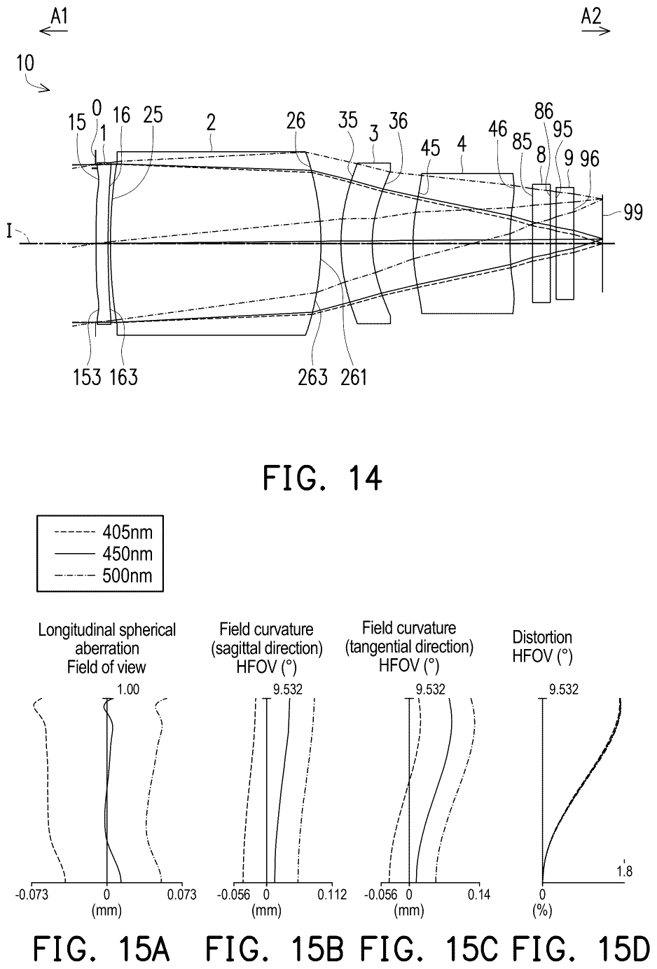

FIG. 14 is a schematic diagram of an optical imaging lens of a third embodiment of the disclosure. FIG. 15A to FIG. 15D are diagrams of a longitudinal spherical aberration and various optical aberrations of the optical imaging lens of the third embodiment. First, referring to FIG. 14, the third embodiment of the optical imaging lens 10 of the disclosure is approximately similar to the first embodiment, and their differences are as follows: the optical data, aspheric coefficients, and parameters among the lens elements 1, 2, 3, and 4 are more or less different. Furthermore, in the embodiment, the first lens element 1 has negative refracting power. The periphery region 153 of the object-side surface 15 of the first lens element 1 is concave. The periphery region 163 of the image-side surface 16 of the first lens element 1 is concave. The second lens element 2 has positive refracting power. The optical axis region 261 of the image-side surface 26 of the second lens element 2 is convex, and the periphery region 263 thereof is convex. It should be noted here that, in order to clearly show the figure, reference numerals of the optical axis regions and the periphery regions with surface shapes similar to those of the first embodiment are partially omitted in FIG. 14.

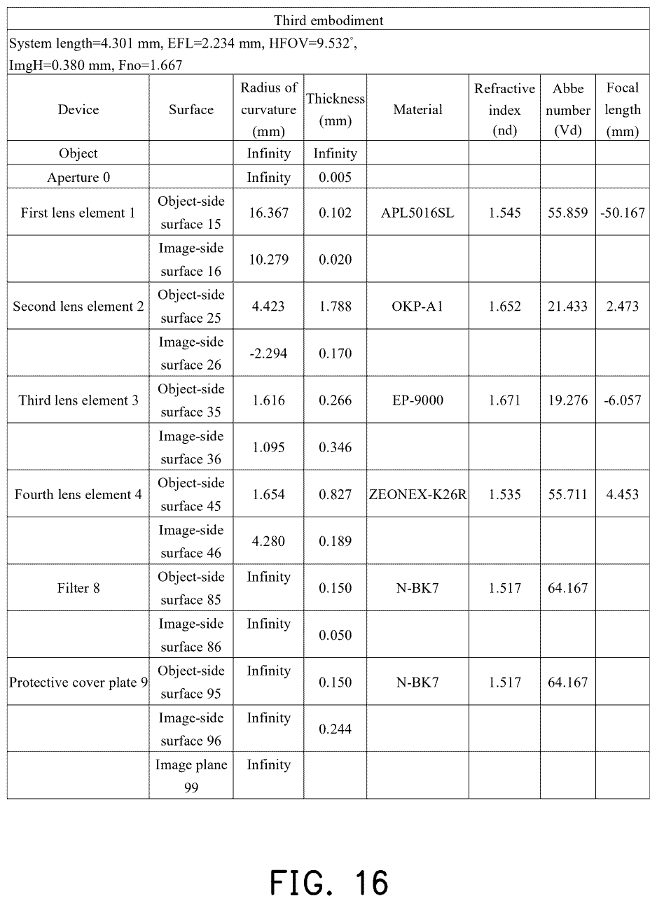

Detailed optical data of the optical imaging lens 10 of the third embodiment is as shown in FIG. 16, and the optical imaging lens 10 of the third embodiment has an effective focal length of 2.234 millimeters, a half field of view of 9.532 degrees, a system length of 4.301 millimeters, an f-number of 1.667, and an image height of 0.380 millimeters.

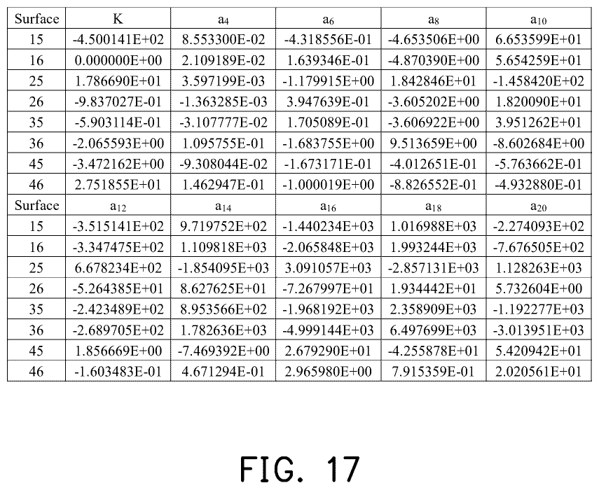

As shown in FIG. 17, FIG. 17 shows the aspheric coefficients of the object-side surface 15 of the first lens element 1 to the image-side surface 46 of the fourth lens element 4 of the third embodiment in Formula (1) above.

In addition, the relationships between important parameters in the optical imaging lens 10 of the third embodiment are as shown in FIG. 42 and FIG. 43.

The longitudinal spherical aberration of the third embodiment is as shown in FIG. 15A, with deviations of imaging points of off-axis rays at different heights are controlled within a range of ±0.073 millimeters. In the two field curvature aberration diagrams of FIG. 15B and FIG. 15C, focal length variations of the three representative wavelengths within the entire field of view range fall within ±0.14 millimeters. The distortion aberration diagram of FIG. 15D shows that the distortion aberration of the embodiment is maintained within a range of ±1.8%.

From the above description, it can be known that the image height of the third embodiment is larger than the image height of the first embodiment. Therefore, compared with the first embodiment, the third embodiment has better sensitivity. Furthermore, the distortion aberration of the third embodiment is smaller than the distortion aberration of the first embodiment, resulting in better imaging quality.

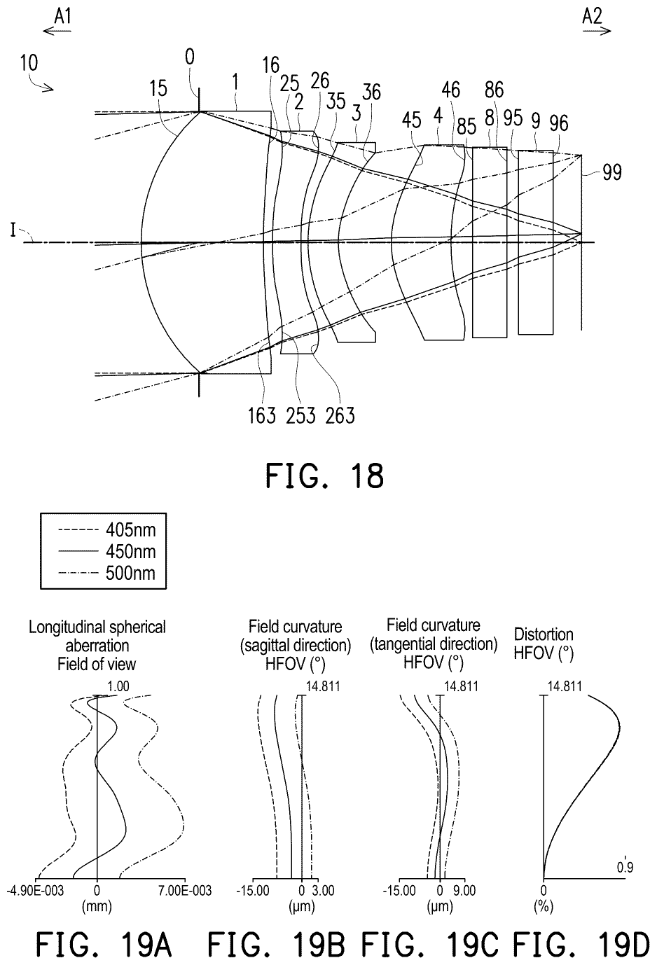

FIG. 18 is a schematic diagram of an optical imaging lens of a fourth embodiment of the disclosure. FIG. 19A to FIG. 19D are diagrams of a longitudinal spherical aberration and various optical aberrations of the optical imaging lens of the fourth embodiment. First, referring to FIG. 18, the fourth embodiment of the optical imaging lens 10 of the disclosure is approximately similar to the first embodiment, and their differences are as follows: the optical data, aspheric coefficients, and parameters among the lens elements 1, 2, 3, and 4 are more or less different. In addition, in the embodiment, the periphery region 163 of the image-side surface 16 of the first lens element 1 is concave. The second lens element 2 has positive refracting power. The periphery region 253 of the object-side surface 25 of the second lens element 2 is concave. The periphery region 263 of the image-side surface 26 of the second lens element 2 is convex. It should be noted here that, in order to clearly show the figure, reference numerals of the optical axis regions and the periphery regions with surface shapes similar to those of first embodiment are partially omitted in FIG. 18.

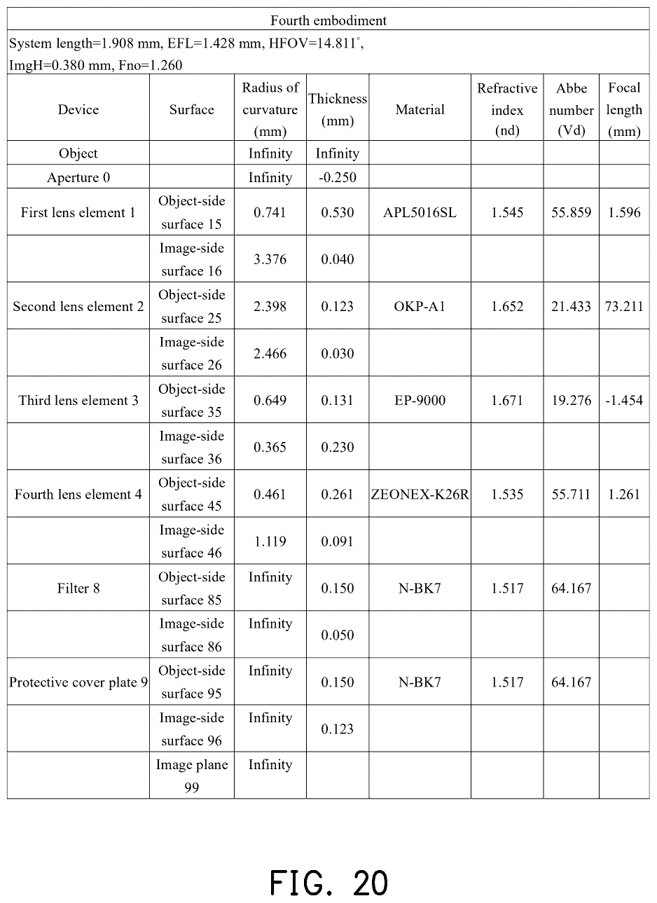

Detailed optical data of the optical imaging lens 10 of the fourth embodiment is as shown in FIG. 20, and the optical imaging lens 10 of the fourth embodiment has an effective focal length of 1.428 millimeters, a half field of view of 14.811 degrees, a system length of 1.908 millimeters, an f-number of 1.260, and an image height of 0.380 millimeters.

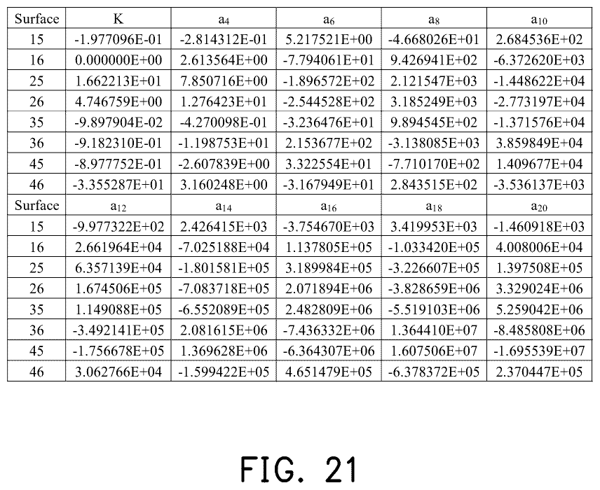

As shown in FIG. 21, FIG. 21 shows the aspheric coefficients of the object-side surface 15 of the first lens element 1 to the image-side surface 46 of the fourth lens element 4 of the fourth embodiment in Formula (1) above.

In addition, the relationships between important parameters in the optical imaging lens 10 of the fourth embodiment are as shown in FIG. 42 and FIG. 43.

The longitudinal spherical aberration of the fourth embodiment is as shown in FIG. 19A, and deviations of imaging points of off-axis rays at different heights are controlled within a range of ±7.00E-003 millimeters. In the two field curvature aberration diagrams of FIG. 19B and FIG. 19C, focal length variations of the three representative wavelengths within the entire field of view range fall within ±15.00 micrometers. The distortion aberration diagram of FIG. 19D shows that the distortion aberration of the embodiment is maintained within a range of ±0.9%.

From the above description, it can be known that the half field of view of the fourth embodiment is larger than the half field of view of the first embodiment. Therefore, compared with the first embodiment, the fourth embodiment has a larger angle range for receiving images. The image height of the fourth embodiment is larger than the image height of the first embodiment. Therefore, compared with the first embodiment, the fourth embodiment has better sensitivity. In addition, the distortion aberration of the fourth embodiment is smaller than the distortion aberration of the first embodiment, resulting in better imaging quality.

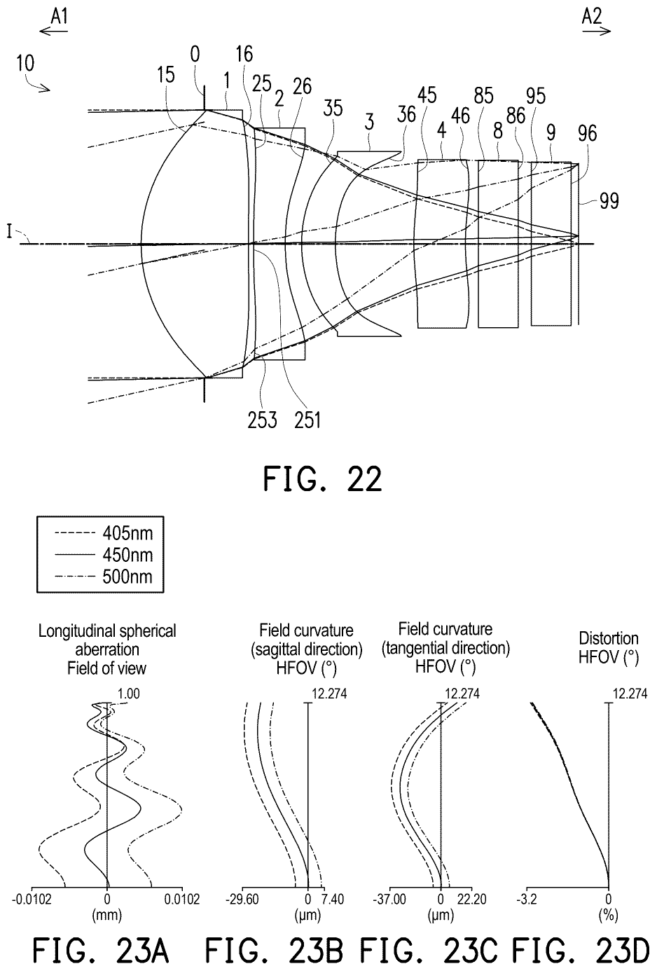

FIG. 22 is a schematic diagram of an optical imaging lens of a fifth embodiment of the disclosure. FIG. 23A to FIG. 23D are diagrams of a longitudinal spherical aberration and various optical aberrations of the optical imaging lens of the fifth embodiment. First, referring to FIG. 22, the fifth embodiment of the optical imaging lens 10 of the disclosure is approximately similar to the first embodiment, and their differences are as follows: the optical data, aspheric coefficients, and parameters among the lens elements 1, 2, 3, and 4 are more or less different. In addition, the optical axis region 251 of the object-side surface 25 of the second lens element 2 is concave, and the periphery region 253 thereof is concave. The third lens element 3 has positive refracting power. The fourth lens element 4 has negative refracting power. It should be noted here that, in order to clearly show the figure, reference numerals of the optical axis regions and the periphery regions with surface shapes similar to those of the first embodiment are partially omitted in FIG. 22.

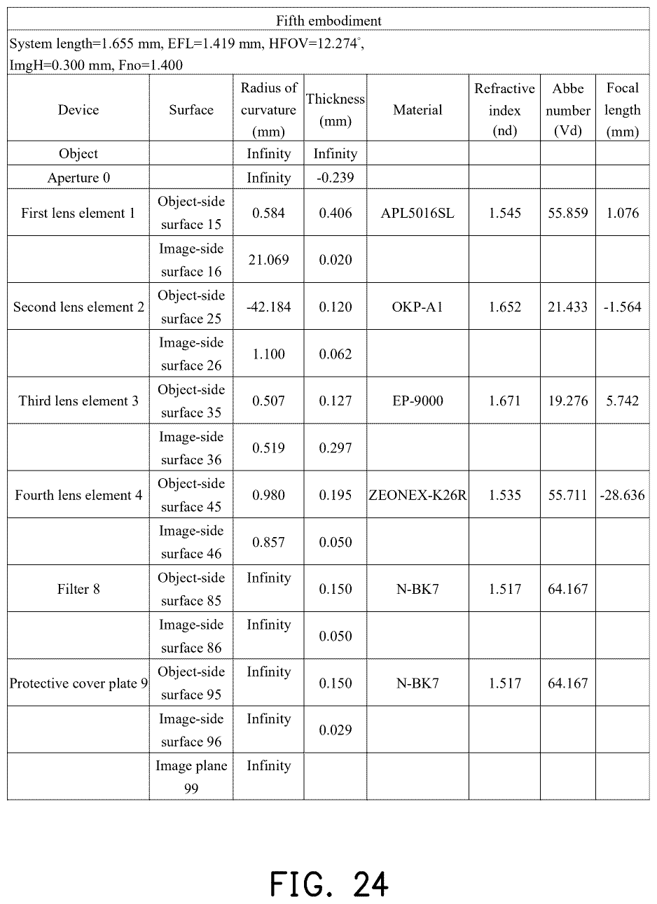

Detailed optical data of the optical imaging lens 10 of the fifth embodiment is as shown in FIG. 24, and the optical imaging lens 10 of the fifth embodiment has an effective focal length of 1.419 millimeters, a half field of view of 12.274 degrees, a system length of 1.655 millimeters, an f-number of 1.400, and an image height of 0.300 millimeters.

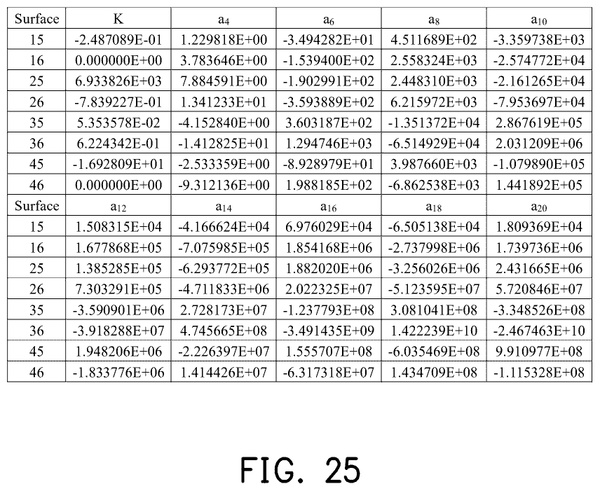

As shown in FIG. 25, FIG. 25 shows the aspheric coefficients of the object-side surface 15 of the first lens element 1 to the image-side surface 46 of the fourth lens element 4 of the fifth embodiment in Formula (1) above.

In addition, the relationships between important parameters in the optical imaging lens 10 of the fifth embodiment are as shown in FIG. 42 and FIG. 43.

The longitudinal spherical aberration of the fifth embodiment is as shown in FIG. 23A, and deviations of imaging points of off-axis rays at different heights are controlled within a range of ±0.0102 millimeters. In the two field curvature aberration diagrams of FIG. 23B and FIG. 23C, focal length variations of the three representative wavelengths within the entire field of view range fall within ±37.00 micrometers. The distortion aberration diagram of FIG. 23D shows that the distortion aberration of the embodiment is maintained within a range of ±3.2%.

From the above description, it can be known that the system length of the fifth embodiment is smaller than the system length of the first embodiment. Therefore, compared with the first embodiment, the fifth embodiment has a smaller volume. The image height of the fifth embodiment is larger than the image height of the first embodiment. Therefore, compared with the first embodiment, the fifth embodiment has better sensitivity. In addition, the distortion aberration of the fifth embodiment is smaller than the distortion aberration of the first embodiment, resulting in better imaging quality.

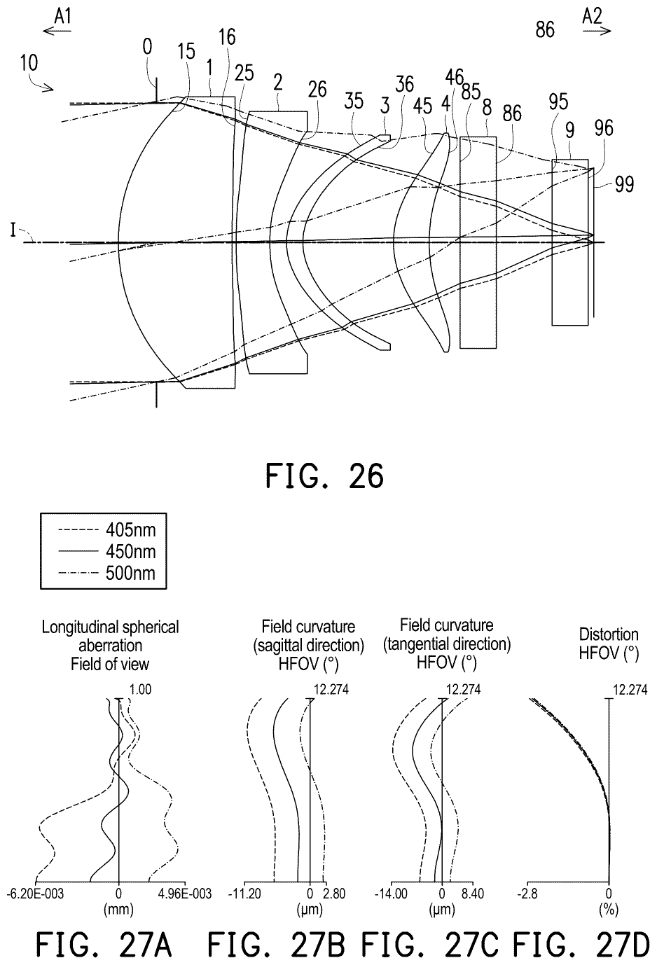

FIG. 26 is a schematic diagram of an optical imaging lens of a sixth embodiment of the disclosure. FIG. 27A to FIG. 27D are diagrams of a longitudinal spherical aberration and various optical aberrations of the optical imaging lens of the sixth embodiment. First, referring to FIG. 26, the sixth embodiment of the optical imaging lens 10 of the disclosure is approximately similar to the first embodiment, and their differences are as follows: the optical data, aspheric coefficients, and parameters among the lens elements 1, 2, 3, and 4 are more or less different. In addition, in the embodiment, the third lens element 3 has positive refracting power. It should be noted here that, in order to clearly show the figure, reference numerals of the optical axis regions and the periphery regions with surface shapes similar to those of the first embodiment are partially omitted in FIG. 26.

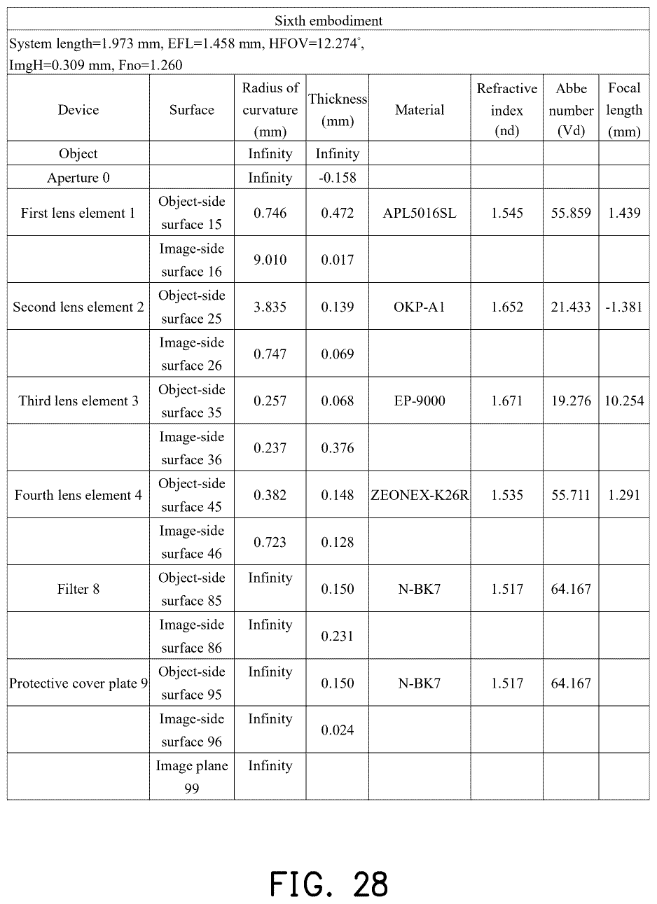

Detailed optical data of the optical imaging lens 10 of the sixth embodiment is as shown in FIG. 28, and the optical imaging lens 10 of the sixth embodiment has an effective focal length of 1.458 millimeters, a half field of view of 12.274 degrees, a system length of 1.973 millimeters, an f-number of 1.260, and an image height of 0.309 millimeters.

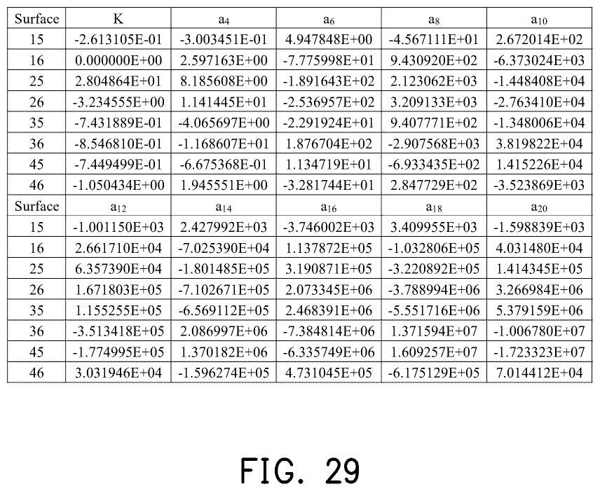

As shown in FIG. 29, FIG. 29 shows the aspheric coefficients of the object-side surface 15 of the first lens element 1 to the image-side surface 46 of the fourth lens element 4 of the sixth embodiment in Formula (1) above.

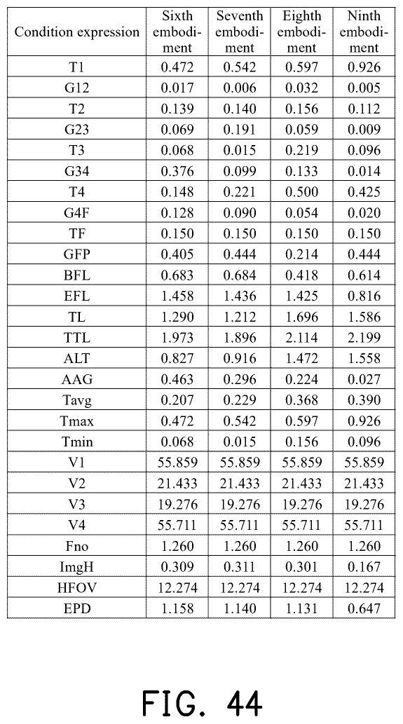

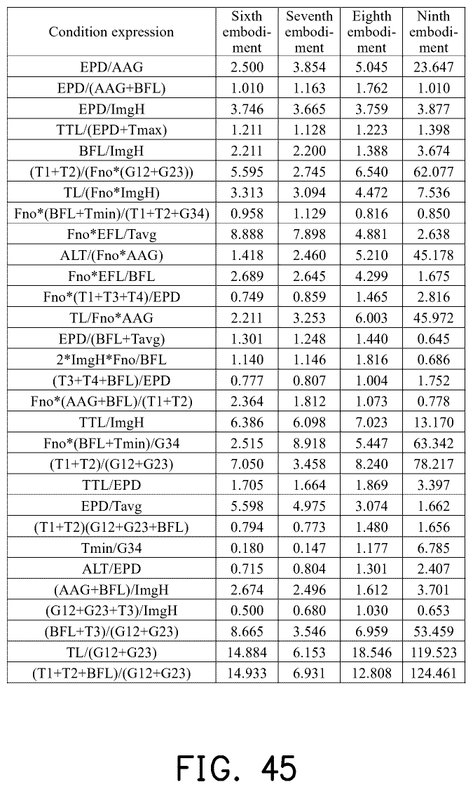

In addition, the relationships between important parameters in the optical imaging lens 10 of the sixth embodiment are as shown in FIG. 44 and FIG. 45.

The longitudinal spherical aberration of the sixth embodiment is as shown in FIG. 27A, and deviations of imaging points of off-axis rays at different heights are controlled within a range of ±6.20E-003 millimeters. In the two field curvature aberration diagrams of FIG. 27B and FIG. 27C, focal length variations of the three representative wavelengths within the entire field of view range fall within ±14.00 micrometers. The distortion aberration diagram of FIG. 27D shows that the distortion aberration of the embodiment is maintained within a range of ±2.8%.

From the above description, it can be known that the image height of the sixth embodiment is larger than the image height of the first embodiment. Therefore, compared with the first embodiment, the sixth embodiment has better sensitivity. In addition, the distortion aberration of the sixth embodiment is smaller than the distortion aberration of the first embodiment, resulting in better imaging quality.

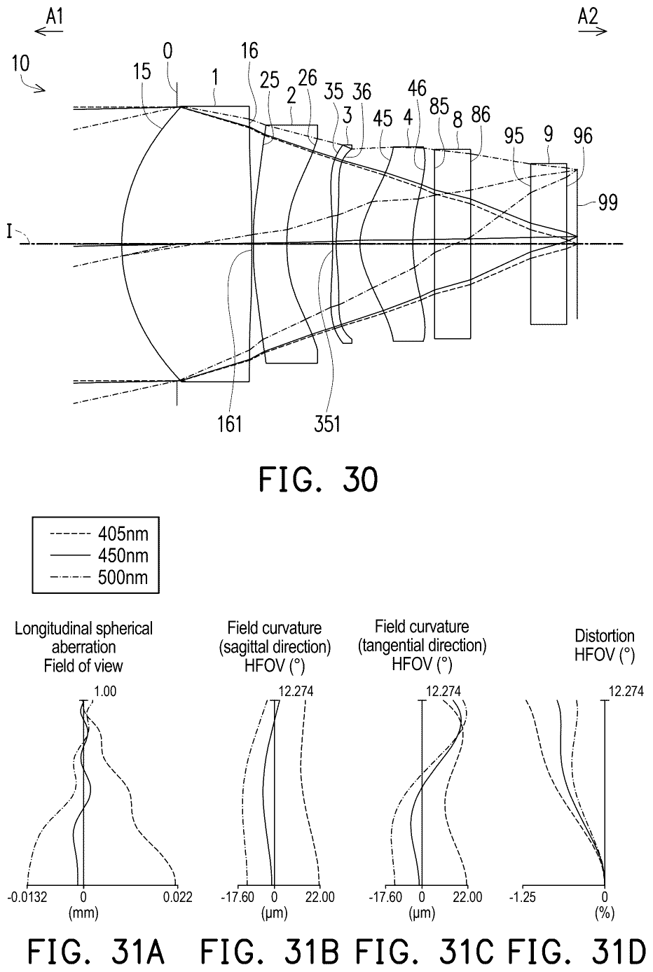

FIG. 30 is a schematic diagram of an optical imaging lens of a seventh embodiment of the disclosure. FIG. 31A to FIG. 31D are diagrams of a longitudinal spherical aberration and various optical aberrations of the optical imaging lens of the seventh embodiment. First, referring to FIG. 30, the seventh embodiment of the optical imaging lens 10 of the disclosure is approximately similar to the first embodiment, and their differences are as follows: the optical data, aspheric coefficients, and parameters among the lens elements 1, 2, 3, and 4 are more or less different. In addition, in the embodiment, the optical axis region 161 of the image-side surface 16 of the first lens element 1 is convex. The optical axis region 351 of the object-side surface 35 of the third lens element 3 is concave. It should be noted here that, in order to clearly show the figure, reference numerals of the optical axis regions and the periphery regions with surface shapes similar to those of the first embodiment are partially omitted in FIG. 30.

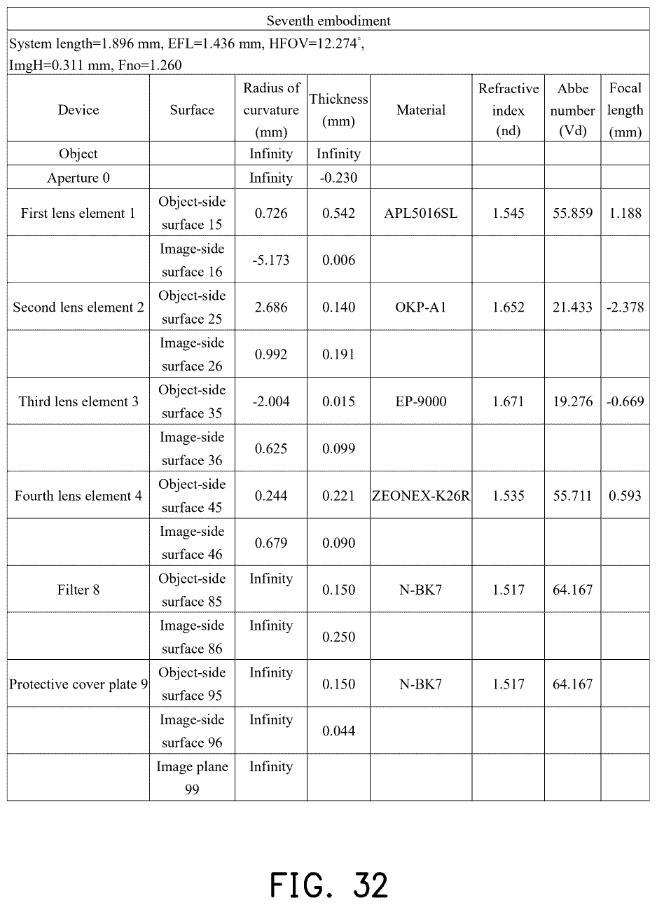

Detailed optical data of the optical imaging lens 10 of the seventh embodiment is as shown in FIG. 32, and the optical imaging lens 10 of the seventh embodiment has an effective focal length of 1.436 millimeters, a half field of view of 12.274 degrees, a system length of 1.896 millimeters, an f-number of 1.260, and an image height of 0.311 millimeters.

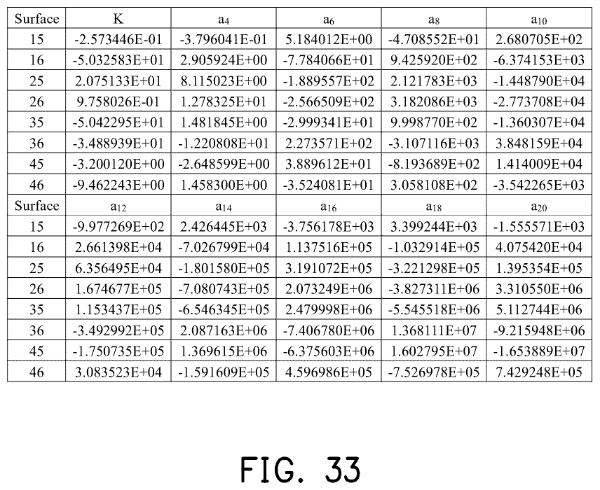

As shown in FIG. 33, FIG. 33 shows the aspheric coefficients of the object-side surface 15 of the first lens element 1 to the image-side surface 46 of the fourth lens element 4 of the seventh embodiment in Formula (1) above.

In addition, the relationships between important parameters in the optical imaging lens 10 of the seventh embodiment are as shown in FIG. 44 and FIG. 45.

The longitudinal spherical aberration of the seventh embodiment is as shown in FIG. 31A, and deviations of imaging points of off-axis rays at different heights are controlled within a range of ±0.022 millimeters. In the two field curvature aberration diagrams of FIG. 31B and FIG. 31C, focal length variations of the three representative wavelengths within the entire field of view range fall within ±22.00 micrometers. The distortion aberration diagram of FIG. 31D shows that the distortion aberration of the embodiment is maintained within a range of ±1.25%.

From the above description, it can be known that the image height of the seventh embodiment is larger than the image height of the first embodiment. Therefore, compared with the first embodiment, the seventh embodiment has better sensitivity. In addition, the distortion aberration of the seventh embodiment is smaller than the distortion aberration of the first embodiment, resulting in better imaging quality.

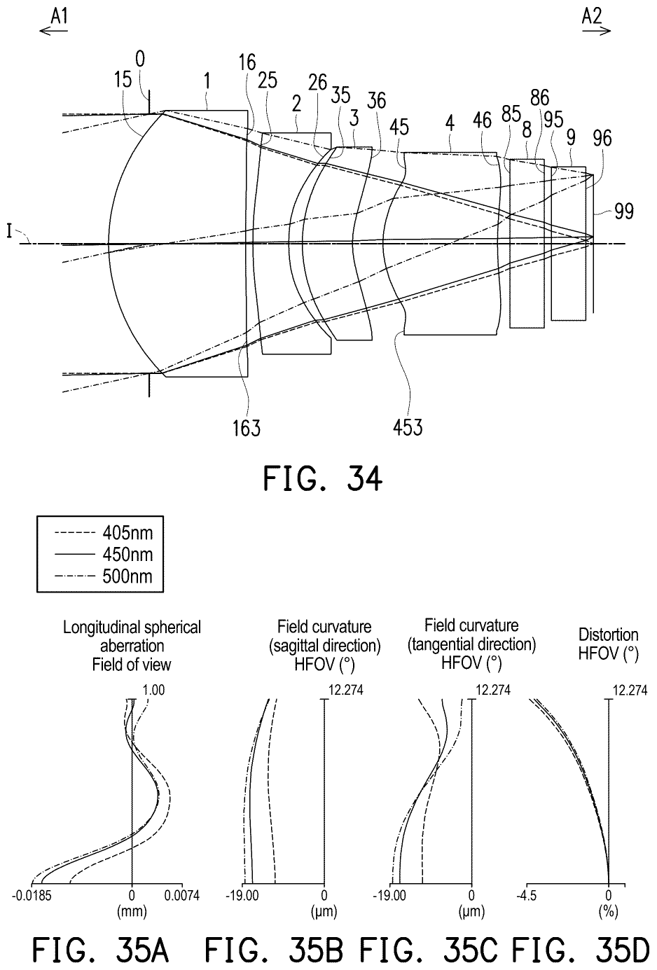

FIG. 34 is a schematic diagram of an optical imaging lens of an eighth embodiment of the disclosure. FIG. 35A to FIG. 35D are diagrams of a longitudinal spherical aberration and various optical aberrations of the optical imaging lens of the eighth embodiment. First, referring to FIG. 34, the eighth embodiment of the optical imaging lens 10 of the disclosure is approximately similar to the first embodiment, and their differences are as follows: the optical data, aspheric coefficients, and parameters among the lens elements 1, 2, 3, and 4 are more or less different. In addition, in the embodiment, the periphery region 163 of the image-side surface 16 of the first lens element 1 is concave. The periphery region 453 of the object-side surface 45 of the fourth lens element 4 is concave. It should be noted here that, in order to clearly show the figure, reference numerals of the optical axis regions and the periphery regions with surface shapes similar to those of the first embodiment are partially omitted in FIG. 34.

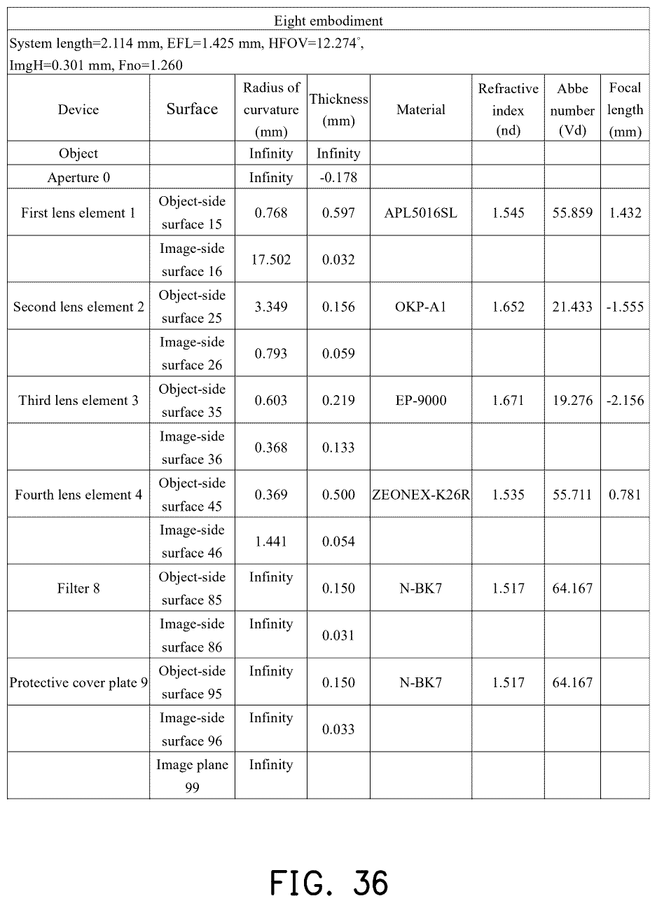

Detailed optical data of the optical imaging lens 10 of the eighth embodiment is as shown in FIG. 36, and the optical imaging lens 10 of the eighth embodiment has an effective focal length of 1.425 millimeters, a half field of view of 12.274 degrees, a system length of 2.114 millimeters, an f-number of 1.260, and an image height of 0.301 millimeters.

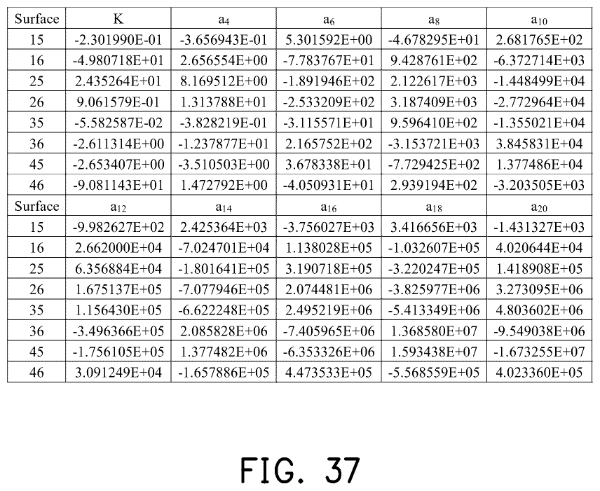

As shown in FIG. 37, FIG. 37 shows the aspheric coefficients of the object-side surface 15 of the first lens element 1 to the image-side surface 46 of the fourth lens element 4 of the eighth embodiment in Formula (1) above.

In addition, the relationships between important parameters in the optical imaging lens 10 of the eighth embodiment are as shown in FIG. 44 and FIG. 45.

The longitudinal spherical aberration of the eighth embodiment is as shown in FIG. 35A, and deviations of imaging points of off-axis rays at different heights are controlled within a range of ±0.0185 millimeters. In the two field curvature aberration diagrams of FIG. 35B and FIG. 35C, focal length variations of the three representative wavelengths within the entire field of view range fall within ±19.00 micrometers. The distortion aberration diagram of FIG. 35D shows that the distortion aberration of the embodiment is maintained within a range of ±4.5%.

From the above description, it can be known that the image height of the eighth embodiment is larger than the image height of the first embodiment. Therefore, compared with the first embodiment, the eighth embodiment has better sensitivity.

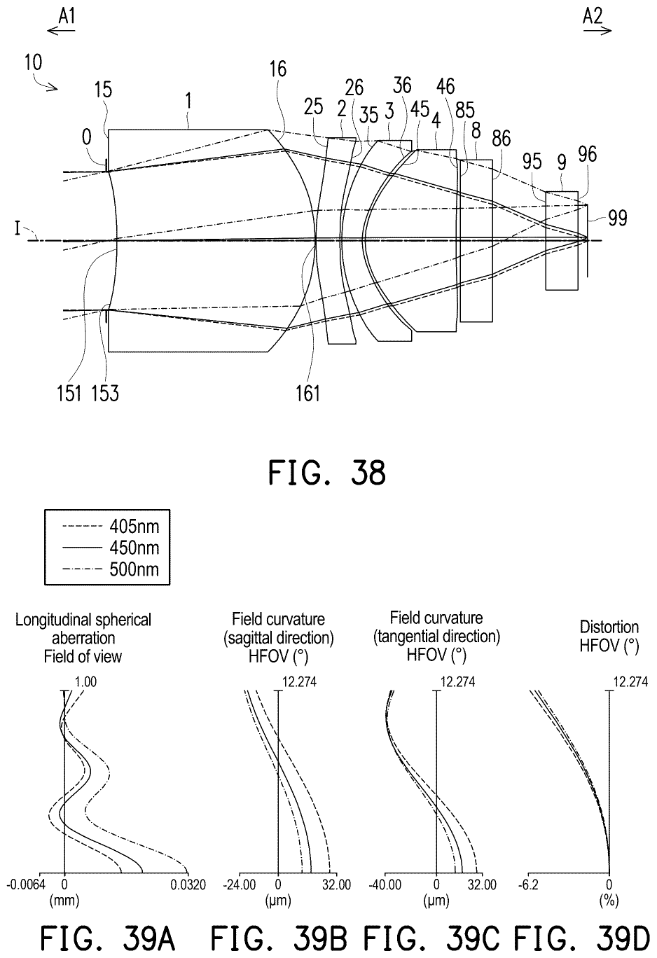

FIG. 38 is a schematic diagram of an optical imaging lens of a ninth embodiment of the disclosure. FIG. 39A to FIG. 39D are diagrams of a longitudinal spherical aberration and various optical aberrations of the optical imaging lens of the ninth embodiment. First, referring to FIG. 38, the ninth embodiment of the optical imaging lens 10 of the disclosure is approximately similar to the first embodiment in general, and their differences are as follows: the optical data, aspheric coefficients, and parameters among the lens elements 1, 2, 3, and 4 are more or less different. In addition, in the embodiment, the optical axis region 151 of the object-side surface 15 of the first lens element 1 is concave, and its periphery region 153 is concave. The optical axis region 161 of the image-side surface 16 of the first lens element 1 is convex. The second lens element 2 has positive refracting power. It should be noted here that, in order to clearly show the figure, reference numerals of the optical axis regions and the periphery regions with surface shapes similar to the first embodiment are partially omitted in FIG. 38.

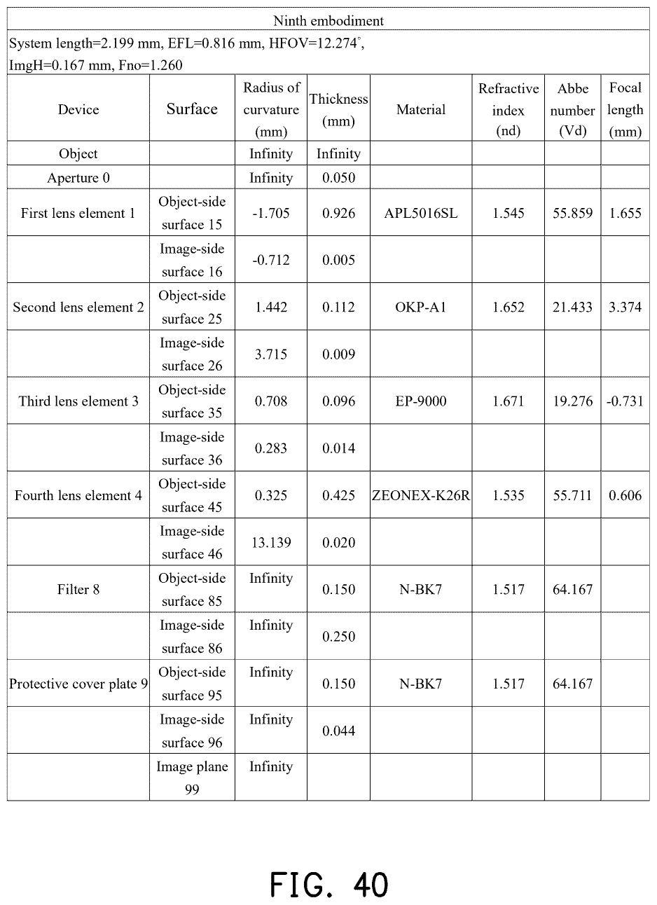

Detailed optical data of the optical imaging lens 10 of the ninth embodiment is as shown in FIG. 40, and the optical imaging lens 10 of the ninth embodiment has an effective focal length of 0.816 millimeters, a half field of view of 12.274 degrees, a system length of 2.199 millimeters, an f-number of 1.260, and an image height of 0.167 millimeters.

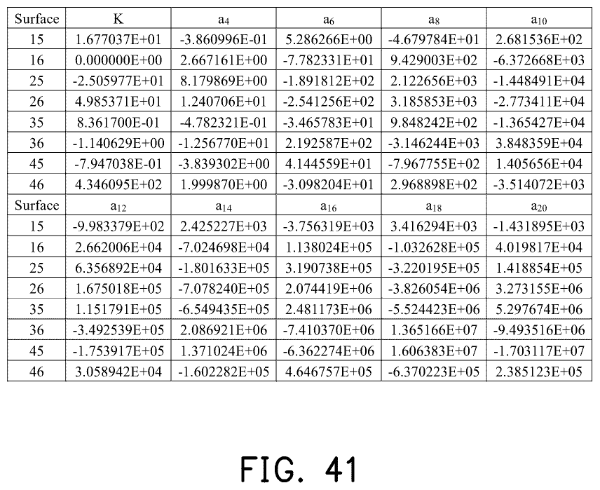

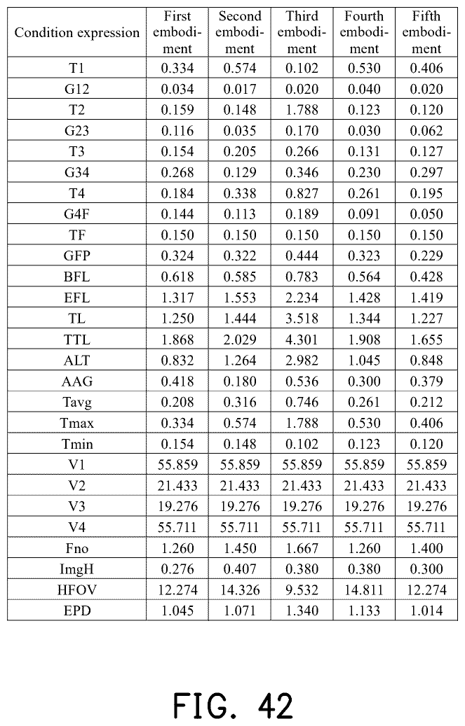

As shown in FIG. 41, FIG. 41 shows the aspheric coefficients of the object-side surface 15 of the first lens element 1 to the image-side surface 46 of the fourth lens element 4 of the ninth embodiment in Formula (1) above.

In addition, the relationships between important parameters in the optical imaging lens 10 of the ninth embodiment are as shown in FIG. 44 and FIG. 45.

The longitudinal spherical aberration of the ninth embodiment is as shown in FIG. 39A, and deviations of imaging points of off-axis rays at different heights are controlled within a range of ±0.032 millimeters. In the two field curvature aberration diagrams of FIG. 39B and FIG. 39C, focal length variations of the three representative wavelengths within the entire field of view range fall within ±40.00 micrometers. The distortion aberration diagram of FIG. 39D shows that the distortion aberration of the embodiment is maintained within a range of ±6.2%.

From the above description, it can be known that the ninth embodiment is easy to manufacture and thus has a higher yield.

In summary of the foregoing, referring to FIG. 42 to FIG. 45 in conjunction, FIG. 42 to FIG. 45 shows table diagrams of various optical parameters of the first embodiment to the ninth embodiment. The optical imaging lens 10 of the embodiments of the disclosure may achieve the following:

I. When the optical imaging lens 10 of the disclosure satisfies the conditions that the optical axis region 361 of the image-side surface 36 of the third lens element 3 is concave and the optical axis region 461 of the image-side surface 46 of the fourth lens element 4 is concave, the aberration in the central field of view of the image plane 99 may be corrected. Furthermore, with the specific surface shape of the periphery region of certain lens elements, such as when the periphery region 463 of the image-side surface 46 of the fourth lens element 4 is convex, the distortion in the peripheral field of view may be further corrected. After adjusting the entrance pupil diameter and air gap to achieve the ratio limitation of EPD/AAG≥2.500, better imaging quality may be achieved while increasing the luminous flux, where the preferable range of EPD/AAG is 2.500≤EPD/AAG≤6.500.

II. When the optical imaging lens 10 of the disclosure satisfies the conditions that the optical axis region 361 of the image-side surface 36 of the third lens element 3 is concave and the optical axis region 461 of the image-side surface 46 of the fourth lens element 4 is concave, the aberration in the central field of view of the image plane 99 may be corrected. Furthermore, with the specific surface shape of the periphery region of certain lens elements, such as when the periphery region 353 of the object-side surface 35 of the third lens element 3 is convex and the periphery region 463 of the image-side surface 46 of the fourth lens element 4 is convex, the distortion in the peripheral field of view may be further corrected. After adjusting the entrance pupil diameter, air gap, and back focal length to achieve the ratio limitation of EPD/(AAG+BFL)≥1.000, better imaging quality may be achieved while reducing the system length and increasing the luminous flux, where the preferable range of EPD/(AAG+BFL) is 1.000≤EPD/(AAG+BFL)≤1.500.

III. When the periphery region 453 of the object-side surface 45 of the fourth lens element 4 is convex, in conjunction with other surface shape limitations, it may be beneficial for further reducing distortion aberration.

IV. When the optical imaging lens 10 of the disclosure satisfies the condition that the optical axis region 461 of the image-side surface 46 of the fourth lens element 4 is concave, the aberration in the central field of view of the image plane 99 may be corrected. Furthermore, with the specific surface shape of the periphery region of certain lens elements, such as when the periphery region 353 of the object-side surface 35 of the third lens element 3 is convex and the periphery region 463 of the image-side surface 46 of the fourth lens element 4 is convex, the distortion in the peripheral field of view may be further corrected. After adjusting the entrance pupil diameter and image height to achieve the ratio limitation of EPD/ImgH≥2.600, better imaging quality may be achieved while increasing the luminous flux and balancing the system focal length and half field of view, where the preferable range of EPD/ImgH is 2.600≤EPD/ImgH≤4.000.

V. When the disclosure satisfies one of the following conditions: the refracting power of the first lens element 1 is positive, the periphery region 153 of the object-side surface 15 of the first lens element 1 is convex, the periphery region 163 of the image-side surface 16 of the first lens element 1 is convex, the refracting power of the second lens element 2 is negative, the optical axis region 261 of the image-side surface 26 of the second lens element 2 is concave, or the periphery region 263 of the image-side surface 26 of the second lens element 2 is concave, it may be beneficial for correcting the field curvature aberration and improving the imaging quality.

VI. In order to reduce the system length of the lens element and ensure the imaging quality, while considering the difficulty of manufacturing, the means of reducing the air gaps between lens elements or appropriately reducing the thicknesses of the lens elements are employed in conjunction with specific image height limitations. When the numerical limitations of the following conditional expressions are satisfied, the embodiments of the disclosure may have a better configuration, which may improve the aberration and distortion of the optical imaging lens 10. When satisfying the preferable range, the spherical aberration may be further improved,
where
the optical imaging lens 10 satisfies TTL/ImgH≥4.900, with a preferable range of 4.900≤TTL/ImgH≤12.500;
the optical imaging lens 10 satisfies (T1+T2)/(G12+G23)≥3.200, with a preferable range of 3.200≤(T1+T2)/(G12+G23)≤15.000;
the optical imaging lens 10 satisfies (T1+T2)(G12+G23+BFL)≥0.600, with a preferable range of 0.600≤(T1+T2)(G12+G23+BFL)≤2.200;
the optical imaging lens 10 satisfies Tmin/G34≤1.200, with a preferable range of 0.150≤Tmin/G34≤1.200;
the optical imaging lens 10 satisfies (G12+G23+T3)/ImgH≥0.500, with a preferable range of 0.500≤(G12+G23+T3)/ImgH≤1.300;
the optical imaging lens 10 satisfies (BFL+T3)/(G12+G23)≥3.500, with a preferable range of 3.500≤(BFL+T3)/(G12+G23)≤17.000;
the optical imaging lens 10 satisfies TL/(G12+G23)≥6.100, with a preferable range of 6.100≤TL/(G12+G23)≤31.000;
the optical imaging lens 10 satisfies BFL/ImgH≥1.000, with a preferable range of 1.000≤BFL/ImgH≤2.400;
the optical imaging lens 10 satisfies (AAG+BFL)/ImgH≥1.600, with a preferable range of 1.600≤(AAG+BFL)/ImgH≤2.800; and
the optical imaging lens 10 satisfies (T1+T2+BFL)/(G12+G23)≥6.900, with a preferable range of 6.900≤(T1+T2+BFL)/(G12+G23)≤28.000.

VII. In order to simultaneously possess a larger luminous flux and better imaging quality, in addition to balancing the f-number and system focal length to achieve an appropriate entrance pupil diameter, it is also necessary to adjust the thicknesses of the lens elements and the air gaps therebetween in the system. When the numerical limitations of the following conditional expressions are satisfied, the embodiments of the disclosure may have a better configuration, which may improve the aberration and distortion of the optical imaging lens 10. When satisfying the preferable range, the spherical aberration may be further improved,
where
the optical imaging lens 10 satisfies EPD/AAG≥2.500, with a preferable range of 2.500≤EPD/AAG≤6.500;
the optical imaging lens 10 satisfies EPD/(AAG+BFL)≥1.000, with a preferable range of 1.000≤EPD/(AAG+BFL)≤1.500;
the optical imaging lens 10 satisfies EPD/ImgH≥2.600, with a preferable range of 2.600≤EPD/ImgH≤4.000;
the optical imaging lens 10 satisfies TTL/(EPD+Tmax)≤1.400, with a preferable range of 1.000≤TTL/(EPD+Tmax)≤1.400;
the optical imaging lens 10 satisfies (T1+T2)/(Fno*(G12+G23))≥2.600, with a preferable range of 2.600≤(T1+T2)/(Fno*(G12+G23))≤10.500;
the optical imaging lens 10 satisfies TL/(Fno*ImgH)≥2.400, with a preferable range of 2.400≤TL/(Fno*ImgH)≤6.000;
the optical imaging lens 10 satisfies Fno*EFL/Tavg≤9.500, with a preferable range of 6.000≤Fno*EFL/Tavg≤9.500;
the optical imaging lens 10 satisfies ALT/(Fno*AAG)≥1.400, with a preferable range of 1.400≤ALT/(Fno*AAG)≤5.200;
the optical imaging lens 10 satisfies Fno*(T1+T3+T4)/EPD≤1.550, with a preferable range of 0.700≤Fno*(T1+T3+T4)/EPD≤1.550;
the optical imaging lens 10 satisfies TL/(Fno*AAG)≥2.200, with a preferable range of 2.200≤TL/Fno*AAG≤6.000;
the optical imaging lens 10 satisfies TTL/EPD≤3.250, with a preferable range of 1.500≤TTL/EPD≤3.250;
the optical imaging lens 10 satisfies EPD/Tavg≥1.750, with a preferable range of 1.750≤EPD/Tavg≤6.000;
the optical imaging lens 10 satisfies ALT/EPD≤2.250, with a preferable range of 0.650≤ALT/EPD≤2.250;
the optical imaging lens 10 satisfies Fno*(BFL+Tmin)/(T1+T2+G34)≤1.300, with a preferable range of 0.600≤Fno*(BFL+Tmin)/(T1+T2+G34)≤1.300;
the optical imaging lens 10 satisfies Fno*EFL/BFL≤4.800, with a preferable range of 2.400≤Fno*EFL/BFL≤4.800;
the optical imaging lens 10 satisfies EPD/(BFL+Tavg)≥0.870, with a preferable range of 0.870≤EPD/(BFL+Tavg)≤1.700;
the optical imaging lens 10 satisfies 2*ImgH*Fno/BFL≤2.050, with a preferable range of 1.000≤2*ImgH*Fno/BFL≤2.050;
the optical imaging lens 10 satisfies (T3+T4+BFL)/EPD≤1.400, with a preferable range of 0.700≤(T3+T4+BFL)/EPD≤1.400;
the optical imaging lens 10 satisfies Fno*(AAG+BFL)/(T1+T2)≤2.650, with a preferable range of 1.000≤Fno*(AAG+BFL)/(T1+T2)≤2.650; and
the optical imaging lens 10 satisfies Fno*(BFL+Tmin)/G34≤9.000, with a preferable range of 2.000≤Fno*(BFL+Tmin)/G34≤9.000.

VIII. When the embodiment satisfies one of the conditional expressions: Fno*(T1+T3+T4)/EPD≤1.550, EPD/(BFL+Tavg)≥0.870, (T3+T4+BFL)/EPD≤1.400, Fno*(BFL+Tmin)/G34≤9.000, TTL/EPD≤3.250, EPD/Tavg≥1.750, Tmin/G34≤1.200, ALT/EPD≤2.250, the distortion may be improved.

IX. The optical imaging lens 10 of the disclosure includes the filter 8, which satisfies the following conditions: an average transmittance of light in the wavelength range of 360 to 380 nm is ≤5%; an average transmittance of light in the wavelength range of 400 to 500 nm is ≥90%; and an average transmittance of light in the wavelength range of 550 to 1150 nm is ≤5%. The foregoing may be beneficial for the optical imaging lens 10 to be applied in the blue light wavelength range of 400 to 500 nm, resulting in significant improvements in the field curvature, distortion, or longitudinal aberration and reflecting good MTF resolution and imaging quality. A preferable limitation is that an average transmittance of light in the wavelength range of 360 to 380 nm is ≤3%; an average transmittance of light in the wavelength range of 400 to 500 nm is ≥95%; and an average transmittance of light in the wavelength range of 550 to 1150 nm is ≤3%.

In addition, any combinational relationship between the parameters of the embodiments may be additionally selected to add limitations on lenses to help with design of lenses with the same structure of the disclosure. In view of the unpredictability of optical system design, under the architecture of the disclosure, satisfying the above conditional expressions may better shorten the system length, reduce the f-number, improve imaging quality, or improve the assembly yield rate in the disclosure over the prior art. Moreover, the use of plastic material for the lens element in the embodiments of the disclosure may further reduce the weight and cost of the lens.

The numerical range including the maximum value and the minimum value obtained from the combinational and proportional relationships between the optical parameters disclosed in the embodiments of the disclosure may be implemented accordingly.

The contents in the embodiments of the invention include but are not limited to a focal length, a thickness of a lens element, an Abbe number, or other optical parameters. For example, in the embodiments of the invention, an optical parameter A and an optical parameter B are disclosed, wherein the ranges of the optical parameters, comparative relation between the optical parameters, and the range of a conditional expression covered by a plurality of embodiments are specifically explained as follows:
(1) The ranges of the optical parameters are, for example, α2≤A≤α1 or β2≤B≤β1, where α1 is a maximum value of the optical parameter A among the plurality of embodiments, α2 is a minimum value of the optical parameter A among the plurality of embodiments, β1 is a maximum value of the optical parameter B among the plurality of embodiments, and β2 is a minimum value of the optical parameter B among the plurality of embodiments.
(2) The comparative relation between the optical parameters is that A is greater than B or A is less than B, for example.
(3) The range of a conditional expression covered by a plurality of embodiments is in detail a combination relation or proportional relation obtained by a possible operation of a plurality of optical parameters in each same embodiment. The relation is defined as E, and E is, for example, A+B or A-B or A/B or A*B or (A*B)½, and E satisfies a conditional expression E≤γ1 or E≥γ2 or γ2≤Σ≤γ1, where each of γ1 and γ2 is a value obtained by an operation of the optical parameter A and the optical parameter B in a same embodiment, γ1 is a maximum value among the plurality of the embodiments, and γ2 is a minimum value among the plurality of the embodiments.

The ranges of the aforementioned optical parameters, the aforementioned comparative relations between the optical parameters, and a maximum value, a minimum value, and the numerical range between the maximum value and the minimum value of the aforementioned conditional expressions are all implementable and all belong to the scope disclosed by the invention. The aforementioned description is for exemplary explanation, but the invention is not limited thereto.

What is claimed is:

1. An optical imaging lens, comprising a first lens element, a second lens element, a third lens element, and a fourth lens element sequentially arranged along an optical axis from an object side to an image side, wherein each of the first lens element to the fourth lens element comprises an object-side surface facing the object side and allowing an imaging ray to pass through and an image-side surface facing the image side and allowing the imaging ray to pass through, wherein
an optical axis region of the image-side surface of the third lens element is concave;
a periphery region of the object-side surface of the fourth lens element is convex;
an optical axis region of the image-side surface of the fourth lens element is concave; and
a periphery region of the image-side surface of the fourth lens element is convex,
wherein lens elements of the optical imaging lens are only the four lens elements, and satisfy a condition as follows: EPD/AAG≥2.500, where EPD is an entrance pupil diameter of the optical imaging lens, and AAG is a sum of three air gaps between the first lens element to the fourth lens element on the optical axis.

2. The optical imaging lens according to claim 1, wherein the optical imaging lens further satisfies a condition as follows: TL/(Fno*ImgH)≥2.400, where TL is a distance from the object-side surface of the first lens element to the image-side surface of the fourth lens element on the optical axis, Fno is an f-number of the optical imaging lens, and ImgH is a maximum image height of the optical imaging lens.

3. The optical imaging lens according to claim 1, wherein the optical imaging lens further satisfies a condition as follows: ALT/(Fno*AAG)≥1.400, where ALT is a sum of thicknesses of the four lens element from the first lens element to the fourth lens element on the optical axis, and Fno is an f-number of the optical imaging lens.

4. The optical imaging lens according to claim 1, wherein the optical imaging lens further satisfies a condition as follows: TL/(Fno*AAG)≥2.200, where TL is a distance from the object-side surface of the first lens element to the image-side surface of the fourth lens element on the optical axis, and Fno is an f-number of the optical imaging lens.

5. The optical imaging lens according to claim 1, wherein the optical imaging lens further satisfies a condition as follows: TTL/ImgH≥4.900, where TTL is a distance from the object-side surface of the first lens element to an image plane on the optical axis, and ImgH is a maximum image height of the optical imaging lens.

6. The optical imaging lens according to claim 1, wherein the optical imaging lens further satisfies a condition as follows: (G12+G23+T3)/ImgH≥0.500, where G12 is an air gap between the first lens element and the second lens element on the optical axis, G23 is an air gap between the second lens element and the third lens element on the optical axis, T3 is a thickness of the third lens element on the optical axis, and ImgH is a maximum image height of the optical imaging lens.

7. The optical imaging lens according to claim 1, wherein the optical imaging lens further satisfies a condition as follows: (T1+T2)(G12+G23+BFL)≥0.600, where T1 is a thickness of the first lens element on the optical axis, T2 is a thickness of the second lens element on the optical axis, G12 is an air gap between the first lens element and the second lens element on the optical axis, G23 is an air gap between the second lens element and the third lens element on the optical axis, and BFL is a distance from the image-side surface of the fourth lens element to an image plane on the optical axis.

8. An optical imaging lens, comprising a first lens element, a second lens element, a third lens element, and a fourth lens element sequentially arranged along an optical axis from an object side to an image side, wherein each of the first lens element to the fourth lens element comprises an object-side surface facing the object side and allowing an imaging ray to pass through and an image-side surface facing the image side and allowing the imaging ray to pass through, wherein
a periphery region of the object-side surface of the third lens element is convex;
an optical axis region of the image-side surface of the third lens element is concave;
a periphery region of the object-side surface of the fourth lens element is convex;
an optical axis region of the image-side surface of the fourth lens element is concave; and
a periphery region of the image-side surface of the fourth lens element is convex,
wherein lens elements of the optical imaging lens are only the four lens elements, and satisfy a condition as follows: EPD/(AAG+BFL)≥1.000, where EPD is an entrance pupil diameter of the optical imaging lens, AAG is a sum of three air gaps between the first lens element to the fourth lens element on the optical axis, and BFL is a distance from the image-side surface of the fourth lens element to an image plane on the optical axis.

9. The optical imaging lens according to claim 8, wherein the optical imaging lens further satisfies a condition as follows: (BFL+T3)/(G12+G23)≥3.500, where T3 is a thickness of the third lens element on the optical axis, G12 is an air gap between the first lens element and the second lens element on the optical axis, and G23 is an air gap between the second lens element and the third lens element on the optical axis.

10. The optical imaging lens according to claim 8, wherein the optical imaging lens further satisfies a condition as follows: TTL/(EPD+Tmax)≤1.400, where TTL is a distance from the object-side surface of the first lens element to the image plane on the optical axis, and Tmax is a maximum value of thicknesses of the four lens element from the first lens element to the fourth lens element on the optical axis.

11. The optical imaging lens according to claim 8, wherein the optical imaging lens further satisfies a condition as follows: TTL/EPD≤3.250, where TTL is a distance from the object-side surface of the first lens element to the image plane on the optical axis.

12. The optical imaging lens according to claim 8, wherein the optical imaging lens further satisfies a condition as follows: (T1+T2)/(Fno*(G12+G23))≥2.600, where T1 is a thickness of the first lens element on the optical axis, T2 is a thickness of the second lens element on the optical axis, Fno is an f-number of the optical imaging lens, G12 is the air gap between the first lens element and the second lens element on the optical axis, and G23 is the air gap between the second lens element and the third lens element on the optical axis.

13. The optical imaging lens according to claim 8, wherein the optical imaging lens further satisfies a condition as follows: Fno*EFL/Tavg≤9.500, where Fno is an f-number of the optical imaging lens, EFL is an effective focal length of the optical imaging lens, and Tavg is an average value of thicknesses of the four lens element from the first lens element to the fourth lens element on the optical axis.

14. The optical imaging lens according to claim 8, wherein the optical imaging lens further satisfies a condition as follows: Fno*(T1+T3+T4)/EPD≤1.550, where Fno is an f-number of the optical imaging lens, T1 is a thickness of the first lens element on the optical axis, T3 is a thickness of the third lens element on the optical axis, and T4 is a thickness of the fourth lens element on the optical axis.

15. An optical imaging lens, comprising a first lens element, a second lens element, a third lens element, and a fourth lens element sequentially arranged along an optical axis from an object side to an image side, wherein each of the first lens element to the fourth lens element comprises an object-side surface facing the object side and allowing an imaging ray to pass through and an image-side surface facing the image side and allowing the imaging ray to pass through, wherein
a periphery region of the object-side surface of the third lens element is convex;
an optical axis region of the image-side surface of the fourth lens element is concave; and
a periphery region of the image-side surface of the fourth lens element is convex,
wherein lens elements of the optical imaging lens are only the four lens elements, and satisfy a condition as follows: EPD/ImgH≥2.600, where EPD is an entrance pupil diameter of the optical imaging lens, and ImgH is a maximum image height of the optical imaging lens.

16. The optical imaging lens according to claim 15, wherein the optical imaging lens further satisfies a condition as follows: (T1+T2)/(G12+G23)≥3.200, where T1 is a thickness of the first lens element on the optical axis, T2 is a thickness of the second lens element on the optical axis, G12 is an air gap between the first lens element and the second lens element on the optical axis, and G23 is an air gap between the second lens element and the third lens element on the optical axis.

17. The optical imaging lens according to claim 15, wherein the optical imaging lens further satisfies a condition as follows: EPD/Tavg≥1.750, where Tavg is an average value of thicknesses of the four lens element from the first lens element to the fourth lens element on the optical axis.

18. The optical imaging lens according to claim 15, wherein the optical imaging lens further satisfies a condition as follows: Tmin/G34≤1.200, where Tmin is a minimum value of thicknesses of the four lens element from the first lens element to the fourth lens element on the optical axis, and G34 is an air gap between the third lens element and the fourth lens element on the optical axis.

19. The optical imaging lens according to claim 15, wherein the optical imaging lens further satisfies a condition as follows: ALT/EPD≤2.250, where ALT is a sum of thicknesses of the four lens element from the first lens element to the fourth lens element on the optical axis.

20. The optical imaging lens according to claim 15, wherein the optical imaging lens further satisfies a condition as follows: TL/(G12+G23)≥6.100, where TL is a distance from the object-side surface of the first lens element to the image-side surface of the fourth lens element on the optical axis, G12 is an air gap between the first lens element and the second lens element on the optical axis, and G23 is an air gap between the second lens element and the third lens element on the optical axis.
